(19) United States
(12) Patent Application Publication
(10) Pub. No.: US 2002/0173341 A1
(43) Pub. Date: Nov. 21, 2002

(54) Method and apparatus for increasing sensitivity in a communication system base station

(76) Inventors: Amr Abdelmonem, Arlington Heights, IL (US); Scott Bundy, Broomfield, CO (US); Benjamin Golant, Crystal Lake, IL (US); Keith Mafield, Schaumburg, IL (US); Ted Myers, East Dundee, IL (US)

Correspondence Address: MARSHALL, GERSTEIN & BORUN, 6300 SEARS TOWER, 233 SOUTH WACKER, CHICAGO, IL, 60606-6357, US

(21) Appl. No.: 09/859,076

(22) Filed: May 16, 2001

(51) Int. Cl. H04M 1/00

(52) U.S. Cl. 455/561; 455/307; 455/296

(57) ABSTRACT

A communication station includes a low-loss filter having an input and an output, wherein the input of the low-loss filter is coupled to an antenna. The low-loss filter is coupled to a low-noise amplifier having an input and an output. The communication station also includes an adaptive notch filter (ANF) module coupled to the output of the low-noise amplifier. A receiver is coupled to the output of the ANF module and is responsive to the communication signal.

### TECHNICAL FIELD

The present invention is directed to communication systems and, more particularly, to a technique for increasing sensitivity in a communication system base station.

### BACKGROUND ART

Wireless communication systems typically include mobile units, such as cellular telephones and the like, that exchange information with land-based infrastructure installations, which are commonly referred to as base stations. Base stations typically include antenna towers for receiving signals from mobile units. As will be readily appreciated, providers of wireless communication systems seek to maximize the sensitivity of such systems to achieve the greatest range and or capacity performance. Capacity improvements can result from either increasing the number of simultaneous messages carried by the receiver communication channel (for example individual voice calls), or by increasing the total throughput of data transmitted by a user on a communication channel.

Several factors compromise the sensitivity of wireless communication system. These factors include, but are not limited to, interference outside the receiver's band of interest, losses associated with the cables, connectors, and other components that comprise the front-end receiver network (e.g. transmission lines, filters, etc.) and noise generated internally due to active components used in the front-end of a receiver for a wireless communication system (e.g. first stage low noise amplifier, or LNA). Additionally, factors affecting receiver sensitivity may also include in-band interference that is created either by other users of the system (either same cell or other cell, in the case of a cellular system with frequency re-use) and interference caused by the undesired mixing of other signals within the pass-band of the wireless receiver system, as in the case of a wireless system that is serving both narrow-band mobiles (e.g. TDMA or analog) and wider band CDMA signals (e.g. IS95, CDMA2000, or WCDMA).

A number of different solutions for each of the above problems exist, and have been described previously. For example, tower mounted amplifiers (TMA's) can reduce the losses associated with a wireless system front-end and also provide improved noise performance by using LNA's having low noise figures. Superconducting front-ends, either mounted on or off the tower, can further reduce losses that degrade the sensitivity of a receiver of a wireless system. Additionally, superconducting front-ends significantly reduce out-of-band interference because of their improved filter rejection performance.

The use of adaptive notch filter (ANF) modules is also known. ANF modules detect narrowband interference, which may be due to signals from, for example, a mobile unit. Furthermore, narrowband interference may be due to a mobile unit that causes intermodulation products in components of a receiver lineup. ANF modules identify and eliminate these undesired mixing products before they are introduced to a wideband receiver.

It would be desirable to maximize the sensitivity improvement of a wireless communication system receiver by combining the positive effects of both a TMA or a superconducting front-end with an ANF module.

### SUMMARY OF THE INVENTION

According to one aspect, the present invention may be embodied in a communication station having an antenna for receiving a communication signal. The communication station may include a low-loss filter having an input and an output, wherein the input of the low-loss filter is coupled to the antenna and a low-noise amplifier having an input and an output, wherein the input of the low-noise amplifier is coupled to the output of the low-loss filter. The communication station may further include an adaptive notch filter (ANF) module having an input and an output, wherein the input of the ANF module is coupled to the output of the low-noise amplifier and a receiver having an input coupled to the output of the ANF module and responsive to the communication signal.

According to a second aspect, the present invention may be embodied in a communication station having an antenna for receiving a communication signal. The communication station may include a low-loss filter having an input and an output, wherein the input of the low-loss filter is coupled to the antenna and a low-noise amplifier having an input and an output, wherein the input of the low-noise amplifier is coupled to the output of the low-loss filter. The communication station may further include a channel filter having an input and an output, wherein the input of the channel filter is coupled to the output of the low-noise amplifier and an adaptive notch filter (ANF) module having an input and an output, wherein the input of the ANF module is coupled to the output of the channel filter. Additionally, the communication station may include a receiver having an input coupled to the output of the ANF module and responsive to the communication signal.

According to a third aspect, the present invention may be embodied in a communication station having an antenna for receiving a communication signal. The communication station may include a low-loss filter having an input and an output, wherein the input of the low-loss filter is coupled to the antenna and a low-noise amplifier having a first gain, an input and an output, wherein the input of the low-noise amplifier is coupled to the output of the low-loss filter. Additionally, the communication station may include an original equipment manufacturer (OEM) front-end having a second gain, an input and an output, wherein the input of the OEM front-end is coupled to the output of the low-noise amplifier and an adaptive notch filter (ANF) module having an input and an output, wherein the input of the ANF module is coupled to the output of the OEM front-end and wherein the first and second gains are optimized to balance noise figure performance and intermodulation distortion performance at the output of the ANF module. Further, the communication station may include a receiver having an input coupled to the output of the ANF module and responsive to the communication signal.

According to a fourth aspect, the present invention may be embodied in a communication station having an antenna for receiving a communication signal. The communication station may include a low-loss filter having an input and an output, wherein the input of the low-loss filter is coupled to the antenna and a low-noise amplifier having an input and an output, wherein the input of the low-noise amplifier is coupled to the output of the low-loss filter. The communication station may further include an adaptive notch filter (ANF) module having an input and an output, wherein the ANF module has an output third-order intercept (TOI) performance that exceeds the equivalent output TOI performance of the low-loss filter and the low-noise amplifier and a receiver having an input coupled to the output of the ANF module and responsive to the communication signal.

According to a fifth aspect, the present invention may be embodied in a communication station having an antenna for receiving a communication signal. The communication station may include an adaptive notch filter (ANF) module having an input and an output, wherein the input of the ANF module is coupled to the antenna, a low-loss filter having an input and an output, wherein the input of the low-loss filter is coupled to the output of the ANF module and a low-noise amplifier having an input and an output, wherein the input of the low-noise amplifier is coupled to the output of the low-loss filter. Additionally, the communication station may include a receiver having an input coupled to the output of low-noise amplifier.

According to a sixth aspect, the present invention may be embodied in a communication station having an antenna for receiving a communication signal. The communication station may include a low-loss filter having an input and an output, wherein the input of the low-loss filter is coupled to the antenna, a low-noise amplifier having an input and an output, wherein the input of the low-noise amplifier is coupled to the output of the low-loss filter and a splitter having an input and an output, wherein the input of the splitter is coupled to the output of the low-noise amplifier. The communication station may further include an attenuator having an input and an output, wherein the input of the attenuator is coupled to the output of the splitter output, a channel filter having an input and an output, wherein the input of the channel filter is coupled to the output of the attenuator and an adaptive notch filter (ANF) module having an input and an output, wherein the input of the ANF module is coupled to the output of the channel filter. The communication station may also include a receiver having an input coupled to the output of the ANF module and responsive to the communication signal.

According to a seventh aspect, the present invention may be embodied in a method of processing a communication signal received by an antenna of a communication station. The method may include filtering the communication signal with a low-loss filter to produce a first signal, amplifying the filtered signal with a low-noise amplifier to produce a second signal and scanning the second signal for narrowband interference and selectively removing narrowband interference therefrom to produce a third signal. The method may also include demodulating the third signal.

These and other features of the present invention will be apparent to those of ordinary skill in the art in view of the description of the preferred embodiments, which is made with reference to the drawings, a brief description of which is provided below.

### BRIEF DESCRIPTION OF THE DRAWINGS

FIG. 1 is an exemplary illustration of a first embodiment of a communication system base station lineup;

FIG. 2 is an exemplary illustration of a second embodiment of a communication system base station lineup;

FIG. 3 is an exemplary illustration of a third embodiment of a communication system base station lineup;

FIG. 4 is an exemplary illustration of a fourth embodiment of a communication system base station lineup;

FIG. 5 is an exemplary illustration of the amplified front-end of FIG. 1;

FIG. 6 is an exemplary illustration of a frequency spectrum of a wideband signal in the absence of interference;

FIG. 7 is an exemplary illustration of a frequency spectrum of a wideband signal in the presence of three narrowband interferers;

FIG. 8 is an exemplary illustration of a frequency spectrum of a wideband signal having three narrowband interferers removed therefrom;

FIG. 9 is an exemplary illustration of one embodiment of an adaptive notch filter (ANF) module of FIG. 1;

FIG. 10 is an exemplary illustration of a second embodiment of an ANF module of FIG. 1;

FIG. 11 is an exemplary illustration of a notch module of FIG. 10;

FIG. 12 is an exemplary illustration of a second embodiment of a notch filter block of FIG. 11;

FIG. 13 is an exemplary flow diagram of a main routine executed by the microcontroller of FIG. 10;

FIG. 14 is an exemplary flow diagram of a setup default values routine executed by the microcontroller of FIG. 10;

FIG. 15 is an exemplary flow diagram of a built in test equipment (BITE) test routine executed by the microcontroller of FIG. 10;

FIG. 16 is an exemplary flow diagram of a signal processing and interference identification routine executed by the microcontroller of FIG. 10;

FIG. 17 is an exemplary flow diagram of an interference extraction routine executed by the microcontroller of FIG. 10;

FIG. 18 is an exemplary flow diagram of a fail condition check routine executed by the microcontroller of FIG. 10;

FIGS. 19A and 19B form an exemplary flow diagram of a main routine executed by the operations, alarms and metrics (OA&M) processor of FIG. 10;

FIG. 20 is an exemplary flow diagram of a prepare response routine executed by the OA&M processor of FIG. 10;

FIG. 21 is an exemplary flow diagram of a data buffer interrupt function executed by the OA&M processor of FIG. 10;

FIG. 22 is an exemplary illustration of a first embodiment of a duplexing front end that may be used in conjunction with communication base station lineups;

FIG. 23 is an exemplary illustration of a second embodiment of a duplexing front end that may be used in conjunction with communication base station lineups;

FIG. 24 is an exemplary schematic diagram of a first embodiment of a dual-duplex front-end that may be used in conjunction with the duplexing front end of FIG. 23;

FIG. 25 is an exemplary schematic diagram of a second embodiment of a dual-duplex front-end that may be used in conjunction with the duplexing front end of FIG. 23;

FIG. 26 is an exemplary schematic diagram of a single-duplex front-end that may be used in conjunction with the duplexing front end of FIG. 23;

FIG. 27 is an exemplary schematic diagram of a front-end with diversity reception that may be used in conjunction with the duplexing front end of FIG. 23;

FIG. 28 is an exemplary schematic diagram of an high temperature superconductor (HTS) duplexer that may be used in conjunction with the duplexing front end of FIG. 23;

FIG. 29 is an exemplary block diagram of a first embodiment of a front-end system having multiple outputs; and

FIG. 30 is an exemplary block diagram of a second embodiment of a front-end system having multiple outputs.

### DESCRIPTION OF THE EMBODIMENTS

The present invention is generally directed to RF communication systems having increased sensitivity. Increased sensitivity is a byproduct of the combination of a superconducting front end with an adaptive notch filter (ANF) module. In general, the superconducting front-end provides a low noise floor and low noise figure so that weak signals from mobile units can be received by the base station. The ANF module, as described in detail below, eliminates narrowband interference, such as intermodulation distortion (IMD) or any other in-band interference, from a received signal before the received signal is coupled to a receiver.

The present invention may, but need not, be incorporated into a wireless communication station, such as a base station for a cellular, PCS (personal communication systems), or other wireless system. While particularly useful in a base station context, the present invention may be applied in a variety of communication systems to realize increased sensitivity. In accordance with one aspect of the present invention, low-loss technologies, such as filtering in a cryogenic environment with conventional and/or high temperature superconductor (HTS) components, are utilized to provide filtering and amplification with minimal introduction of noise into the signal being filtered and amplified.

The following description will set forth the invention in a single-sector context for purposes of clarity only. As will be readily apparent to those skilled in the art, the invention may be easily applied in a system having one or more additional antennas for coverage of a multiple-sector cell. In such cases, diversity systems may be implemented according to the teachings of U.S. Pat. No. 5,828,944, entitled “Diversity Reception Signal Processing System,” the disclosure of which is hereby incorporated by reference.

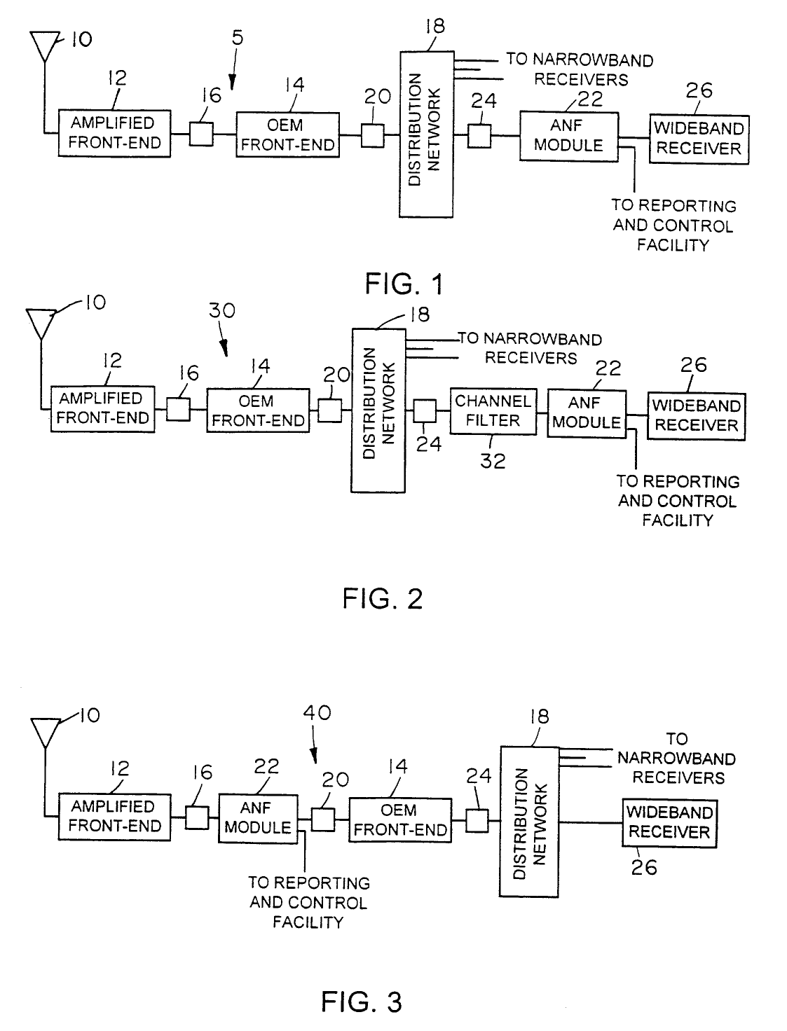

With reference to FIG. 1, a base station lineup 5 includes an antenna 10, which may be disposed upon and supported by an antenna tower, may be coupled to an amplified front-end (hereinafter “front-end”) 12, further detail of which is described below in conjunction with FIG. 5. The front-end 12 may be coupled to an original equipment manufacturer (OEM) front-end (hereinafter “OEM front-end”) 14. An exemplary OEM front-end is available from Lucent. Such a connection may take place through an optional attenuation pad 16. The output of the OEM front-end 14 may be connected to a distribution network (hereinafter “splitter”) 18 via an optional attenuation pad 20. Alternatively, the splitter 18 may be integrated with the OEM front-end 14.

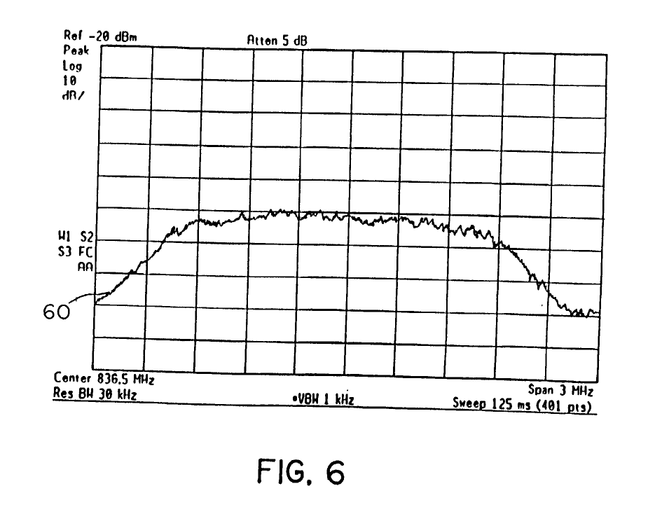

The splitter 18 divides the signal from the OEM front-end 14 into a number of different paths. For example, the splitter 18 may divide the signal from the OEM front-end 14 into six different paths. One such path may be coupled to an ANF module 22 via an optional attenuation pad 24. The ANF module 22, which is described in detail with respect to FIGS. 6-21, may be coupled to a wideband receiver 26, which may be embodied in, for example, a code-division multiple access (CDMA) receiver, a wideband CDMA (WCDMA) receiver, a cdma 2000 receiver, fixed wireless or any other suitable wideband receiver capable of demodulating the received signal. Additionally, the ANF module 22 may be coupled via the Internet, telephone lines or any other suitable media to a reporting and control facility. In some networks, the reporting and control facility may be integrated with other base station components.

During operation, a received signal from the antenna 10 is filtered and amplified by the front-end 12, which, as described in detail in conjunction with FIG. 5, has a very low noise floor and low noise figure. The signal received by the antenna 10 may include information encoded in both wideband and narrowband formats, if the base station lineup 5 processes both narrowband analog cellular (e.g., AMPS) signals or time-division multiple access (TDMA) signals as well as wideband signals such as CDMA signals. The narrowband signals may be disposed at frequencies above and below the frequency band used to carry the wideband signals.

Alternatively, in other applications, wideband signals may be processed by a lineup that also processes ultra wideband signals. For example, wideband signals having bandwidths of 1 MHz may be processed by a lineup that processes ultra wideband signals having bandwidths of 100 MHz. It is contemplated that the present invention is applicable to systems having two signals, wherein one of the signals has a bandwidth that is significantly wider than the other signal.

After the received signal has been amplified and filtered by the front-end 12, the OEM front-end 14 filters and amplifies the signal from the front-end 12 and couples the signal to the ANF module 22, which scans the received signal for narrowband interference and, upon detecting narrowband interference, filters the received signals to remove the narrowband interference, before coupling the received signal, which has been filtered and had narrowband interference removed therefrom, to the wideband receiver 26.

It should be noted with respect to FIG. 1 that the OEM front-end 14 and the splitter 18 are optional. In particular, FIG. 1 illustrates how an existing system including an OEM front-end 14 and a splitter 18 could be retrofitted with the front-end 12 and the ANF module 22 to enhance the sensitivity of a base station. The sale of an original system may not include the OEM front-end 14 and the splitter 18. In particular, because the front-end 12 noise performance and filtering characteristics are generally superior to those of the OEM front-end 14, the OEM front-end 14 could be eliminated in a new system for sale. Additionally, if the system of FIG. 1 operated only on a single wideband signal and not on a wideband signal and narrowband signals, the splitter 18 could be eliminated and the single wideband signal could be coupled directly from the front-end 12 to the ANF module 22. Accordingly, while FIG. 1 exemplifies a retrofit system, an equipment manufacturer could produce a new system using only components 10, 12 and 22 of FIG. 1.

Having generally described the components 10-26 of FIG. 1, attention is now turned to the considerations made in selecting the order in which the components 10-26 are connected in consideration of noise figure and IMD products. In general, the order in which base station components are placed and the characteristics that those components possess affect the performance of a wideband receiver that processes signals that are passed through the base station lineup. In addition to the base station lineup 5 described in connection with FIG. 1, other base station configurations will be described in conjunction with FIGS. 2-4.

The following discussion relevant to base station lineups pertains to, among other things, noise figure and third-order intercept (TOI) points of various components of a base station lineup. Noise figure is a figure of merit representative of the noise generated within a component. Noise figure is determined by taking the difference, in decibels (dB), between the signal-to-noise ratio (SNR) of a component input and the SNR of a component output.

Accordingly, if a component has a 50 dB SNR at its input and has a 49 dB SNR at its output, the noise figure of that component is 1 dB. The lower the noise figure of a component, the better the noise performance of that component. Additionally, TOI is a measure of component performance that represents how the component responds to high signal level inputs. In particular, TOI is the theoretical point at which fundamental response level of a component is equivalent to IMD products generated by the component. The higher the TOI of a particular component, the better the IMD performance of that component. As used hereinafter, TOI refers to an output TOI of a component, which may also be stated as the TOI as referenced to the output of a component. The equivalent TOI refers to the TOI at a point in a base station lineup that accounts for the most likely worst case interfering signal(s), the frequency selectivity of all filters at the worst case interfering signal(s) frequencies, the gains of all preceding components and the TOI performance of all preceding components.

In general, numerous factors may be considered when outfitting a base station lineup 5 with a front-end 12 and an ANF module 22. First, the gain levels between each stage of the base station lineup 5 should be considered. Generally, a higher front-end gain will reduce, or improve, overall base station lineup 5 noise figure, while the same increase in front-end gain can reduce the TOI performance of the base station lineup 5. The gain levels assigned to the front-end 12 and the OEM front-end 14, filter losses and/or filter rejection of worst case interfering signals, as well as any attenuation pads 16, 20, 24, will all affect the noise figure and IMD products of the base station lineup 5.

The gain levels of a system may be set differently based on the environment in which the base station line up 5 is placed. More particularly, the gain levels may be set based on the interference present in the environment in which the base station line up 5 is placed. For example, in environments having strong in-band interference, it may be desirable to minimize front-end gain, thereby trading noise figure for TOI performance. As a further example, in environments having weak in-band interference, it may be desirable to have a high front-end gain, thereby increasing the noise figure and sacrificing TOI performance. Additionally, if the rejection of a front-end filter is very high, front-end gain can be increased because the signals rejected by the front-end filter, which would have created IMD in the base station lineup 5, have been eliminated.

Secondly, it is advantageous to have the TOI of the ANF module 22 to be equal to, or greater than, the TOI of the base station lineup 5 as referenced to gains and losses in the base station lineup 5, up to the input of the ANF module 22. Said another way, the ANF module 22 has an output TOI performance that exceeds the equivalent TOI performance of the components preceding the ANF module 22. Such a consideration prevents the ANF module 22 from degrading the IMD performance of the base station lineup 5. Either or both of TOI and noise factor may be traded off against one another based on the environment in which the base station lineup 5 operates.

Commonly, tradeoffs made when selecting the order of the components of the base station lineup 5 include trading noise figure performance for IMD performance. If the only concern for the base station lineup 5 performance were noise figure, the front-end 12, which is the first stage of the base station lineup 5, would have a large gain. However, if IMD were the only concern for the base station lineup 5 performance, the front-end 12 would have a smaller gain, because a large gain at the first stage of the base station lineup 5 creates a large signal level that may cause IMD in subsequent components of the base station lineup 5.

Returning to FIG. 1, typically the front-end 12, the OEM front-end 14 and the ANF module 22 may have noise figures of 1 dB, 3-4 dB and 5.5 dB, respectively. Further, the front-end 12, the OEM front-end 14 and the ANF module 22 may have TOIs of 20 decibels over a milliwatt (dBm), 35 dBm and 7 dBm, respectively. The OEM front-end 14, the splitter 18 and the ANF module 22 may have a gains of 20 dB, −9 dB and 0 dB, respectively. The attenuation pads 16, 20 and 24 and the splitter 18 change the level of the signals traversing the base station lineup 5 and, in doing so, impact the overall noise figure and IMD performance of the base station lineup 5.

By selecting the front-end 12 as the first component in the base station lineup 5, the noise figure of the base station lineup 5 is set at a low level. The base station lineup 5, has good potential for noise figure performance because the front-end 12, which has good noise figure performance, is the first component to operate on the signals received by the antenna 10. Additionally, the base station lineup 5 has the ANF module 22 located last in the lineup so that it can eliminate or reduce IMD produced by any components that operate on signals before they reach the ANF module 22.

Because the TOI of the front-end 12 is 25 dBm and because the gain of the OEM front-end 14 is roughly 20 dB, the TOI of the OEM front-end 14 would have to be at least 45 dBm (25 dBm, which is the TOI of the front end, added to the 20 dB gain of the OEM front-end) to avoid being the limiting TOI component, as between the front-end 12 and the OEM front-end 14. Because the OEM front-end 14 has a TOI of roughly 35 dBm, the OEM front-end 14 is the limiting factor, as far as TOI is concerned, for the base station lineup 5 up to the splitter 18.

Because the splitter 18 attenuates the signal from the OEM front-end 14 by 9 dB, the effective TOI at the input to the ANF module 22 is 26 dBm (35 dBm, which is the TOI of the OEM front end, less 9 dB due to the attenuation of the splitter). Accordingly, the ANF module 22 would have to have a TOI of at least 26 dBm to not be the limiting factor in base station lineup 5. Because the exemplary ANF module 22 has a TOI of 7 dBm, the ANF module 22 is the TOI limiter in the base station lineup 5. Although the exemplary ANF module 22 has a TOI of 7 dBm, it is contemplated that other ANF modules may have superior TOI performance to the exemplary ANF module 22. Accordingly, it is contemplated that an ANF module may not necessarily be the limiting factor for TOI in the base station lineup 5.

Turning now to FIG. 2, an alternate base station lineup 30 includes all of the components 10-26 of FIG. 1, but further includes a channel filter 32 disposed between the attenuation pad 24 and the ANF module 22. The base station lineup 30, like the base station lineup 5, has the best potential for noise figure performance because the front-end 12 is the first component to operate on the signals received by the antenna 10. Additionally, like the base station lineup 5, the base station lineup 30 has the ANF module 22 located last in the lineup so that it can eliminate or reduce IMD produced by any components that operate on signals before they reach the ANF module 22. It should be noted that the addition of the channel filter 32 is not necessary in all situations. In particular, the channel filter 32 is advantageous in situations in which the base station lineup 30 handles both narrowband and wideband signals.

The channel filter 32 may be embodied in a conventional comb-line cavity filter or in any other suitable filter structure. In general, the channel filter 32 is provided to enhance the IMD performance of the ANF module 22 by reducing the level of out of band interferers that are coupled to the ANF module 22. High level out of band interferers would create IMD in the ANF module 22. In particular, the channel filter 32 is a filter designed to pass wideband signals, but to filter out narrowband signals that may be on frequencies adjacent to the wideband signal. By attenuating the narrowband signals, that are coupled to the ANF module 22, the IMD performance is enhanced because the narrowband signals that create IMD are reduced by the channel filter 32. For example, if the channel filter 32 attenuates both narrowband interferers that would create IMD in the ANF module 22 by XdB (where X is any number), the absolute power level of the IMD generated by the ANF module 22 would be reduced by 3 XdB. By reducing the narrowband signals that may cause IMD in the ANF module 22, the channel filter 32 makes ANF module 22 appear to have improved TOI performance. Accordingly, by adding the channel filter 32 to the base station lineup 30, the IMD performance of the base station lineup 30 improves.

One consideration regarding the channel filter 32 is the rejection that the channel filter 32 must have so that the ANF module 22 enhances the performance of the base station lineup 30. On the other hand, if the channel filter 32 has an excessive amount of rejection, such excessive rejection may not provide additional benefit to the base station lineup 30 and, therefore, the channel filter 32 may have more rejection than is needed for optimal performance. If such is the case, the channel filter 32 is likely more expensive than it needs to be. Accordingly, the lower and upper bounds of useful rejection for the channel filter 32 must be defined. For purposes of such an analysis, the following values are defined:

G=gain of the front-end 12 cascaded with the OEM front-end 14

S=loss of signal power in the splitter 18

L=additional attenuation of CDMA signals between the splitter 18 and ANF module 22

R=rejection of the channel filter 32 at the narrowband signal frequencies

N=depth of the notch of the ANF module 22 for narrowband interference in the CDMA channel

TOI_{FE}=output third-order-intercept point of the front-end 12 cascaded with the OEM front-end 14

TOI_{ANF}=output third-order-intercept point of the ANF module 22

P_{CDMA}=input power of CDMA signals at input port of the front-end 12

Pᵢₙ=power of analog signals at input port of the front-end 12

Note that all values above are expressed in dB or dBm as appropriate. Throughout this document, all formulas and expressions use values in dB instead of linear values.

First, a value of the minimum filter rejection (Rₘᵢₙ) of the channel filter 32 must be determined so that the configuration with the ANF module 22 will have no worse IMD performance than without the ANF module 22. Second, a value of the maximum filter rejection (Rₘₐₓ) beyond which the channel filter 32 provides no additional protection for the ANF module 22 must be determined. Rₘₐₓ must be determined because when the rejection of the channel filter 32 is greater than Rₘₐₓ, the IMD performance of the base station lineup 30 will be limited by the OEM front-end 14 in any case.

The output power for the CDMA signal at the output of the base station lineup 30 when ignoring the attenuation pad 24, the channel filter 32 and the ANF module 22 is defined by equation 1.

P_{CDMA,out}=P_{CDMA}+G−S (1)

The power of the IMD at the output of the base station lineup 30 when ignoring the attenuation pad 24, the channel filter 32 and the ANF module 22 is defined by equation 2.

P_{int er mod,out}=3(Pᵢₙ+G)−2TOI_{FE}−S (2)

Accordingly, the effective signal-to-interference ratio at the output port of the system not having the channel filter 32 and the ANF module 22 can be written as shown in equation 3.

SIR_{baseline}=[P_{CDMA}+G−S]−[3(Pᵢₙ+G)−2TOI_{FE}−S]=P_{CDMA}−3Pᵢₙ+2(TOI_{FE}−G) (3)

To calculate the IMD characteristics of the base station lineup 30 including the attenuation pad 24, the channel filter 32 and the ANF module 22 the process described below is followed. In particular, the power of the CDMA signal at the output port of the system including the attenuation pad 24, the channel filter 32 and the ANF module 22 is defined by equation 4.

P_{CDMA,out}=P_{CDMA}+G−S−L (4)

The power of the IMD generated by the front-end 12 and the OEM front-end 14 before the ANF module 22, and as notched out by the ANF module 22, can be expressed as shown in equation 5.

P_{int er mod,out}=3(Pᵢₙ+G)−2TOI_{FE}−S−L−N (5)

Accordingly, if the dominant IMD generation mechanism is the combination of the front-end 12 and the OEM front-end 14, the signal-to-interference ratio is given by equation 6.

SIR_{FE}[P_{CDMA}+G−S−L]−[3(Pᵢₙ+G)−2TOI_{FE}−S−L−N]=P_{CDMA}−3Pᵢₙ+2(TOI_{FE}−G)+N (6)

However, if the analog signals are not suppressed by the channel filter 32 prior to the ANF module 22, the ANF module 22 itself generates IMD products. The power of the IMD product at the output of the ANF module 22, as generated by the ANF module 22, can be written as shown in equation 7.

P_{int er mod,out}=3(Pᵢₙ+G−S−L−R)−2TOI_{ANF} (7)

If the dominant IMD mechanism is the ANF module 22, the signal-to-interference ratio at the output port of the front-end 12 and the OEM front-end 14 is given by equation 8.

SIR_{ANF}=[P_{CDMA}+G−S−L]−[3(Pᵢₙ+G−S−L−R)−2TOI_{ANF}]=P_{CDMA}−3Pᵢₙ+2(TOI_{ANF}−G+S+L)+3R (8)

The minimum rejection requirement of the channel filter 32 is driven by the desire that inclusion of the ANF module 22 should make the effects of IMD less noticeable, rather than exacerbating the problems due to IMD of narrowband signals. Therefore, to determine a minimum rejection requirement for the channel filter 32 to be placed in front of the ANF module 32, a comparison must be made between equations 3 and 8. Specifically, if equations 3 and 8 are set equal to each other, the minimum filter rejection required may be determined as show in equation 9.

P_{CDMA}−3Pᵢₙ+2(TOI_{FE}−G)=P_{CDMA}−3Pᵢₙ+2(TOI_{ANF}−G+S+L)+3Rₘᵢₙ (9)

Solving equation 9 for the minimum rejection required yields equation 10.

$${R}_{min} = \frac{2}{3} [ {TOI}_{FE} - {TOI}_{ANF} - S - L ] \qquad ( 10 )$$

The maximum rejection of the channel filter 32 may also be determined. The front-end 12 and the OEM front-end 14 generate IMD products that can be suppressed by the ANF module 22. If these IMD products, even after notching by the ANF module 22, exceed the power level of those generated by the ANF module 22, addition filtering in front of the ANF module 22 provides no incremental benefit. Therefore, to determine the maximum rejection requirement for the channel filter 32, a comparison must be made between equations 6 and 8. In particular, if equations 6 and 8 are set equal to one another, equation 11 shows how the maximum rejection may be calculated.

P_{CDMA}−3Pᵢₙ+2(TOI_{FE}−G)+N=P_{CDMA}−3Pᵢₙ+2(TOI_{ANF}−G+S+L)+3Rₘₐₓ (11)

Solving equation 11 for the maximum rejection required yields equation 12.

$${R}_{max} = \frac{2}{3} [ {TOI}_{FE} - {TOI}_{ANF} - S - L ] + \frac{1}{3} N \qquad ( 12 )$$

As shown above, the channel filter 32 rejection that is required depends on the third-order-intercept points of the ANF module 22 (TOI_{ANF}) and the front-end 12 and the OEM front-end 14 (collectively, TOI_{FE}), the splitter 18 loss (S), any additional attenuation (L), and the depth of the notch ANF module 22 (N). Below are typical values for these attributes.

TOI_{FE}=+34 dBm

TOI_{ANF}=+8 dBm

S=9 dB

L=3.5 dB

N=40 dB

If no additional attenuation is included between the OEM front-end 14 and the ANF module 22, the bounds for the channel filter 32 rejection at the analog signal frequencies are given by equation 13, which shows that the rejection of the channel filter 32 should be between 9 dB and 22.3 dB.

Rₘᵢₙ=9.0 dB≦R≦Rₘₐₓ=22.3 dB (13)

If an additional attenuation of 9 dB is included between the OEM front-end 14 and the ANF module 22 (due to the splitter 18), the bounds for the channel filter 32 rejection at the analog signal frequencies are given by equation 14, which shows that the rejection of the channel filter 32 should be between 3 dB and 16.3 dB.

Rₘᵢₙ=3.0 dB≦R≦Rₘₐₓ=16.3 dB (14)

Turning now to FIG. 3, an alternate base station lineup 40 may have the ANF module 22 disposed between the front-end 12 and the OEM front-end 14 is shown. Such a configuration may be advantageous by having a simplified installation procedure and may be integrated and designed to replace an OEM front-end 14. The ANF module 22 shown in the embodiment of FIG. 3 is effective in eliminating jammers that emit signals falling within the bandwidth of the wideband signal, while not degrading the IMD performance of the base station lineup 40. However, because the ANF module 22 is disposed in the base station lineup 40 before the OEM front-end 14, the ANF module 22 is unable to eliminate any IMD produced by the OEM front-end 14. Additionally, the embodiment of FIG. 3 allows for the addition of the front-end 12 and the ANF module 22 to an existing OEM front-end 14, without the need to modify the existing OEM front-end 14 in any way that might void existing OEM warranties. Further, the embodiment of FIG. 3 may use a single component having the front-end 12 integrated with the ANF module 22.

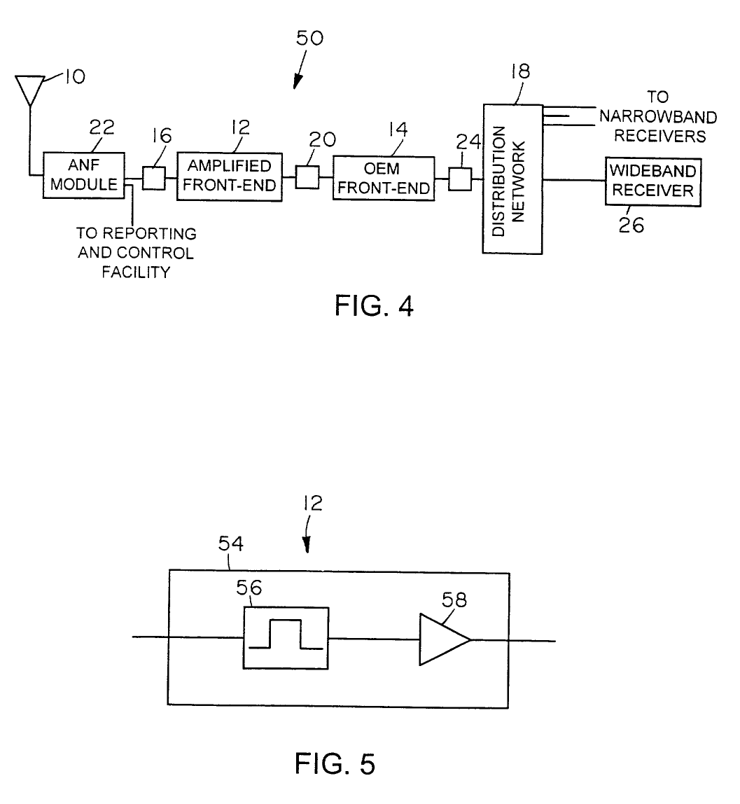

As shown in FIG. 4, an alternate base station lineup 50 that may have the ANF module 22 disposed as the first component after the antenna 10. The embodiment of FIG. 4 effectively eliminates in-band interference due to jammers or interference generated by the antenna 10 or the line connecting the antenna 10 to the ANF module 22. Although an exemplary ANF module 22 may not have good sensitivity properties, as noted above, it is contemplated that ANF modules having superior sensitivity performance may be used in conjunction with any of the embodiments described herein.

Turning now to FIG. 5, the front-end 12 preferably includes cryogenic components in the receive path to maintain minimal losses. For example, the front-end 12 may include a cryostat 54, in which a low loss filter 56 and an amplifier 58 may be disposed. A cryocooler is used to cool the low loss filter 56 and the amplifier 58 that are disposed inside the cryostat 54. In accordance with one embodiment of the present invention, the low loss filter 56 and/or the amplifier 58 may be fabricated using HTS technology.

The front-end 12, may be disposed in a location within an interior portion of the base station lineup 5 where, for example, additional signal processing is accomplished or, alternatively, at, near or on the antenna tower (not shown). In any case, it is desirable to minimize the length of the losses associated with the connection between the antenna 10 and the front-end 12 by placing the front-end 12 as close as possible to the antenna 10. Moreover, base station installations in the United States often involve rather tall antenna towers such that the low-loss, high-performance cabling, which is quite expensive and required for each sector, may significantly add to the costs associated with operation of the wireless system.

Further detail regarding the base station lineup 5 may be found in U.S. Pat. No. 6,104,934, entitled “Cryoelectronic Receiver Front End,” the disclosure of which is hereby incorporated by reference. For instance, the base station lineup 5 may include components and/or structure designed to ensure a stable operating environment. The aforementioned U.S. patent also discloses one manner in which the front-end 12 may be mounted upon and supported by the antenna tower.

FIG. 6 illustrates a frequency spectrum 60 of a wideband signal that may be received at the antenna 10, amplified by the front-end 12 and the OEM front-end 14, distributed by splitter 18 and coupled to the ANF module 22. If the wideband signal received at the antenna 10 has the frequency spectrum 60 as shown in FIG. 6, the ANF module 22 will not filter the wideband signal and will simply couple the wideband signal directly through the ANF module 22 to a CDMA receiver.

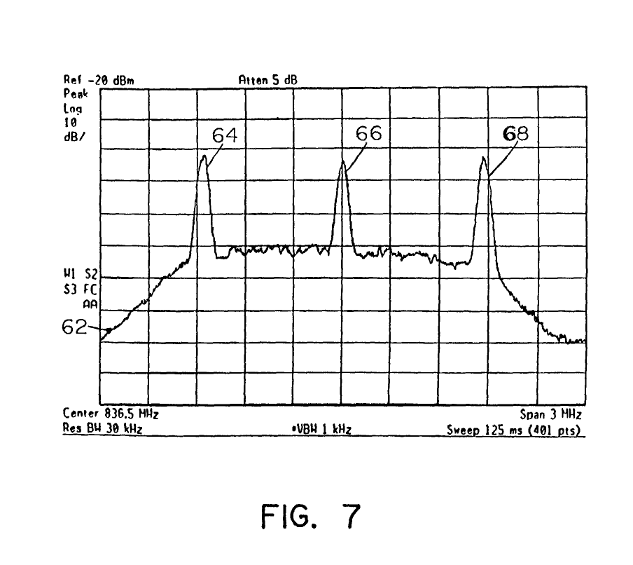

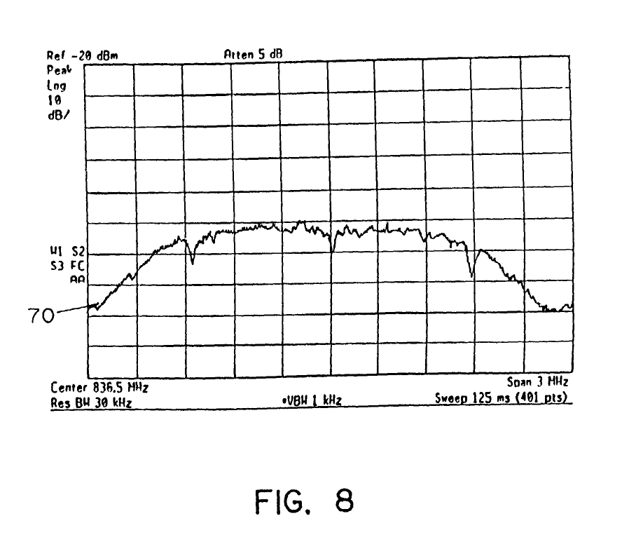

However, as noted previously, it is possible that the wideband signal received by the antenna 10 has a frequency spectrum 62 as shown in FIG. 7. Such a frequency spectrum 62 includes not only the wideband signal having a frequency spectrum similar to the frequency spectrum 60 of FIG. 6, but includes three narrowband interferers 64, 66, 68, as shown in FIG. 7, which may be due to IMD or interference from narrowband mobile units in the geographical area of the base station lineup 5. If a wideband signal having a frequency spectrum 62 including narrowband interferers 64, 66, 68 is received by the antenna 10, amplified and presented to the ANF module 22, the ANF module 22 will filter the frequency spectrum 62 to produce a filtered frequency spectrum 70 as shown in FIG. 8.

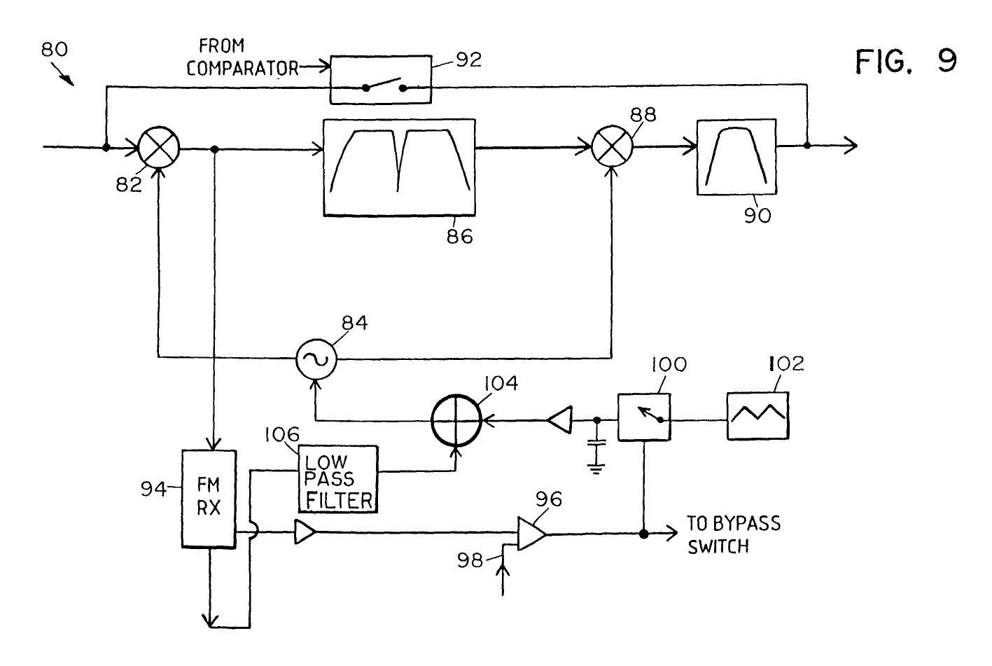

The filtered frequency spectrum 70 has the narrowband interferers 64, 66, 68 removed, therefore leaving a frequency spectrum 70 that is very similar to the frequency spectrum 60, which does not include substantial narrowband interference. The filtered wideband signal may then, as shown in FIGS. 1-4, be coupled from the ANF module 22 to other components in the base station lineup, such as, for example, a CDMA or other wideband receiver, so that the filtered wideband signal spectrum 70 may be demodulated and further processed. Although some of the wideband signal was removed during filtering by the ANF module 22, sufficient wideband signal remains to enable the wideband receiver 26 to recover the information that was broadcast by a mobile unit. Accordingly, in general terms, the ANF module 22 selectively filters wideband signals to remove narrowband interference therefrom. Further detail regarding the ANF module 22 and its operation is provided below in conjunction with FIGS. 9-20.

In general, one embodiment of an ANF module 80, as shown in FIG. 9, scans the frequency spectrum of the received signal, which, as shown in FIGS. 1-4, may be provided by various lineup components, and looks for narrowband interference therein. Such scanning may be implemented by scanning to various known narrowband channels that exist within the bandwidth of the wideband signal. For example, the ANF module 80 may scan to various AMPS channels that lie within the bandwidth of the wideband signal. Alternatively, all of the frequency spectrum encompassed by the wideband signal may be scanned. Either way, when narrowband interference is detected in the wideband signal, the ANF module 80 moves the narrowband interference into the notch of a notch filter, thereby filtering the wideband signal to remove the narrowband interference.

In particular, as shown in FIG. 9, the input signal is coupled to a first mixer 82, which receives an additional input from a voltage controlled oscillator (VCO) 84. The first mixer 82 mixes the input signal with the signal from the VCO 84, thereby shifting the frequency spectrum of the input signal and putting a portion of the shifted frequency spectrum located at intermediate frequency (IF) into a notch frequency of a notch filter 86. Accordingly, the component of the frequency shifted signal that is at the IF is removed by the notch filter 86 having a notch frequency set at the IF.

The resulting filtered signal is coupled from the notch filter 86 to a second mixer 88, which is also driven by the VCO 84. The second mixer 88 mixes the notch filter output with the signal from the VCO 84 to shift the frequency spectrum of the filtered signal back to an original position that the input signal had. The output of the second mixer 88 is coupled to a band pass filter 90, which removes any undesired image frequencies created by the second mixer 88.

In the system of FIG. 9, the narrowband interference present in the wideband signal is mixed to the IF, which is the notch frequency of the notch filter 86, by the first mixer 82 and is, therefore, removed by the notch filter 86. After the narrowband interference has been removed by the notch filter 86, the second mixer 88 restores the signal to its original frequency position, except that the narrowband interference has been removed. Collectively, the first mixer 82, the VCO 84, the notch filter 86, the second mixer 88 and the band pass filter 90 may be referred to as an “up, down filter” or a “down, up filter.”

The input signal is also coupled to a bypass switch 92 so that if no narrowband interference is detected in the input signal, the bypass switch 92 may be enabled to bypass the notch filter 86 and the mixers 82, 88, thereby passing the input signal directly to the next component in the lineup, which, as shown in FIGS. 1-4, may be the wideband receiver 26, the OEM front end 14 or the front-end 12. Alternatively, if narrowband interference is detected, the bypass switch 92 is opened and the input signal is forced to go through the notch filter 86.

To detect the presence of narrowband interference and to effectuate frequency scanning, a number of components are provided. A discriminator 94 receives the output signal from the first mixer 82 and detects signal strength at the IF using a received signal strength indicator (RSSI) that is tuned to the IF. The RSSI output of the discriminator 94 is coupled to a comparator 96, which also receives a threshold voltage on a line 98. When the RSSI signal from the discriminator 94 exceeds the threshold voltage on the line 98, the comparator 96 indicates that narrowband interference is present at the IF, which is the notch frequency of the notch filter 86. When narrowband interference is detected, the sweeping action of the VCO 84 is stopped so that the notch filter 86 can remove the interference at the IF.

To affect the sweeping action of the VCO 84, the output of the comparator 96 is coupled to a sample and hold circuit 100, which receives input from a voltage sweep generator 102. Generally, when no interference is detected by the comparator 96, the output of the voltage sweep generator 102 passes through the sample and hold circuit 10 and is applied to a summer 104, which also receives input from a low pass filter 106 that is coupled to the output of the discriminator 94. The summer 104 produces a signal that drives the VCO 84 in a closed loop manner. As the voltage sweep generator 102 sweeps its output voltage over time, the output of the summer 104 also sweeps, which causes the frequency output of the VCO 84 to sweep over time. The sweeping output of VCO 84, in conjunction with the discriminator 94 and the comparator 96, scan the input signal for interference. As long as the comparator 96 indicates that narrowband interference is not present, the switch 92 is held closed, because there is no need to filter the input signal.

However, when the comparator 96 detects narrowband interference in the input signal (i.e., when the RSSI exceeds the voltage on the line 98), the sample and hold circuit 100 samples the output of the voltage sweep generator 102 and holds the sampled voltage level, thereby providing a fixed voltage to the summer 104, which, in turn, provides a fixed output voltage to the VCO 84. Because a fixed voltage is provided to the VCO 84, the frequency output by the VCO 84 does not change and the input signal is no longer scanned, but is frequency shifted so that the narrowband interference is moved to the IF, which is the notch frequency of the notch filter 86. Additionally, when the comparator 96 indicates that narrowband interference is present, the switch 92 opens and the only path for the input signal to take is the path through the mixers 82, 88 and the notch filter 86.

The threshold voltage on the line 98 may be hand tuned or may be generated by filtering some received signal strength. Either way, the voltage on the line 98 should be set so that the comparator 96 does not indicate that interference is present when only a wideband signal, such as the signal shown in FIG. 6, is present, but only indicates interference when a signal having narrowband interference is present. For example, the frequency spectrum 62 shown in FIG. 7, shows three narrowband interferers 64, 66, 68, only one of the interferers would be needed for the comparator 96 to indicate the presence of narrowband interference. As will be readily appreciated, the embodiment shown in FIG. 9 is only able to select and filter a single narrowband interferer within a wideband signal.

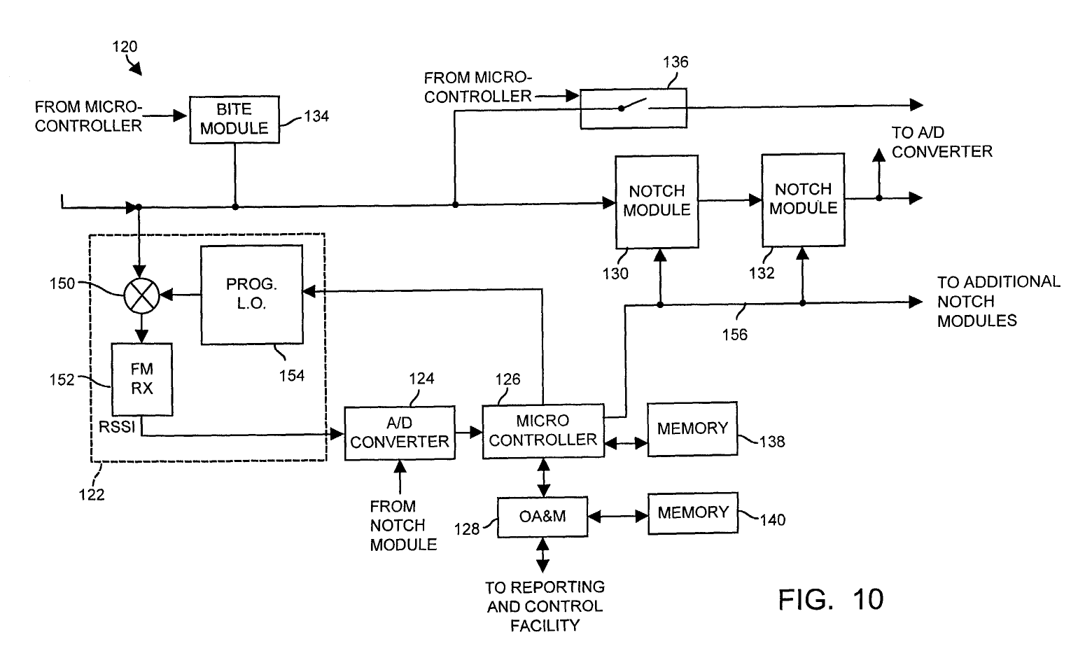

As shown in FIG. 10, a second embodiment of an ANF module 120, which may filter a number of narrowband interferers, generally includes a scanner 122, an analog to digital converter (A/D) 124, a microcontroller 126, an operations, alarms and metrics (OA&M) processor 128 and notch modules, two of which are shown in FIG. 10 at reference numerals 130 and 132. The microcontroller 126 and the OA&M processor 128 may be embodied in a model PIC16C77-20P microcontroller, which is manufactured by Microchip Technology, Inc., and a model 80386 processor, which is manufactured by Intel Corp., respectively. Although they are shown and described herein as separate devices that execute separate software instructions, those having ordinary skill in the art will readily appreciate that the functionality of the microcontroller 126 and the OA&M processor 128 may be merged into a single processing device.

Additionally, the second embodiment of the ANF module 120 may include a built in test equipment (BITE) module 134 and a bypass switch 136, which may be embodied in a model AS239-12 gallium arsenide single-pole, double-throw switch available from Hittite. The microcontroller 126 and the OA&M processor 128 may be coupled to external memories 138 and 140, respectively.

In general, the scanner 122, which includes a mixer 150, a discriminator 152 and a programmable local oscillator 154, interacts with the A/D 124 and the microcontroller 126 to detect the presence of narrowband interference in the input signal. The mixer 150 and the programmable local oscillator 154 may be embodied in a model MD-54-0005 mixer available from M/A-Com and a model AD9831 direct digital synthesizer, which is manufactured by Analog Devices, Inc., respectively. Additionally, the A/D 124 may be completely integrated within the microcontroller 126 or may be a stand alone device coupled thereto.

As described in further detail below, once narrowband interference is detected in the input signal, the microcontroller 126, via a serial bus 156, controls the notch modules 130, 132 to remove the detected narrowband interference. Although the second embodiment of the ANF module 120, as shown in FIG. 10, includes two notch modules 130, 132, additional notch modules may be provided in the ANF module 120. The number of notch modules that may be used in the ANF module 120 is only limited by the signal degradation that each notch module contributes. Because multiple notch modules are provided, multiple narrowband interferers may be removed from the input signal. For example, if three notch modules were provided, a wideband signal having the frequency spectrum 62, as shown in FIG. 7, may be processes by the ANF module 120 to produce a filtered wideband signal having the frequency spectrum 70, as shown in FIG. 8.

The scanner 122 performs its function as follows. The input signal is coupled to the mixer 150, which receives an input from the programmable local oscillator 154. The mixer 150 mixes the input signals down to an IF, which is the frequency that the discriminator 152 analyses to produce an RSSI measurement that is coupled to the A/D 124. The A/D 124 converts the RSSI signal from an analog signal into a digital signal that may be processed by the microcontroller 126. The microcontroller 126 compares the output of the A/D 124 to an adaptive threshold that the microcontroller 126 has previously determined. Details regarding how the microcontroller 126 determines the adaptive threshold are provided hereinafter. If the microcontroller 126 determines that the output from the A/D 124, which represents RSSI, exceeds the adaptive threshold, one of the notch modules 130, 132 may be assigned to filter the input signal at the IF having an RSSI that exceeds the adaptive threshold.

The microcontroller 126 also programs the programmable local oscillator 154 so that the mixer 150 moves various portions of the frequency spectrum of the input signal to the IF that the discriminator 152 processes. For example, if there are 59 narrowband channels that lie within the frequency band of a particular wideband channel, the microcontroller 126 will sequentially program the programmable local oscillator 154 so that each of the 59 channels is sequentially mixed down to the IF by the mixer 150 so that the discriminator 152 can produce RSSI measurements for each channel. Accordingly, the microcontroller 126 uses the programmable local oscillator 154, the mixer 150 and the discriminator 152 to analyze the signal strengths in each of the 59 narrowband channels lying within the frequency band of the wideband signal. By analyzing each of the channels that lie within the frequency band of the wideband signal, the microcontroller 126 can determine an adaptive threshold and can determine whether narrowband interference is present in one or more of the narrowband channels.

Once channels having narrowband interference are identified, the microcontroller 106 may program the notch modules 130, 132 to remove the most damaging interferers, which may, for example, be the strongest interferers. As described in detail hereinafter, the microcontroller 126 may also store lists of channels having interferers, as well as various other parameters. Such a list may be transferred to the reporting and control facility or a base station, via the OA&M processor 128, and may be used for system diagnostic purposes.

Diagnostic purposes may include, but are not limited to, controlling a narrowband receiver (not shown) to obtain particular information relating to an interferer and retasking the interferer by communicating with its base station. For example, the reporting and control facility may use a narrowband receiver to determine the identity of an interferer, such as a mobile unit, by intercepting the electronic serial number (ESN) of the mobile unit, which is sent when the mobile unit transmits information on the narrowband channel. Knowing the identity of the interferer, the reporting and control facility may contact infrastructure that is communicating with the mobile unit and may request the infrastructure to change the transmit frequency of the mobile unit (i.e., the frequency of the narrowband channel on which the mobile unit is transmitting) or may request the infrastructure to drop communications with the interfering mobile unit all together.

Additionally, diagnostic purposes may include using a narrowband receiver to determine a telephone number that the mobile unit is attempting to contact and, optionally handling the call. For example, the reporting and control facility may use a narrowband receiver to determine that the user of the mobile unit was dialing 911, or any other emergency number, and may, therefore, decide that a narrowband receiver should be used to handle the emergency call by routing the output of a narrowband receiver to a telephone network.

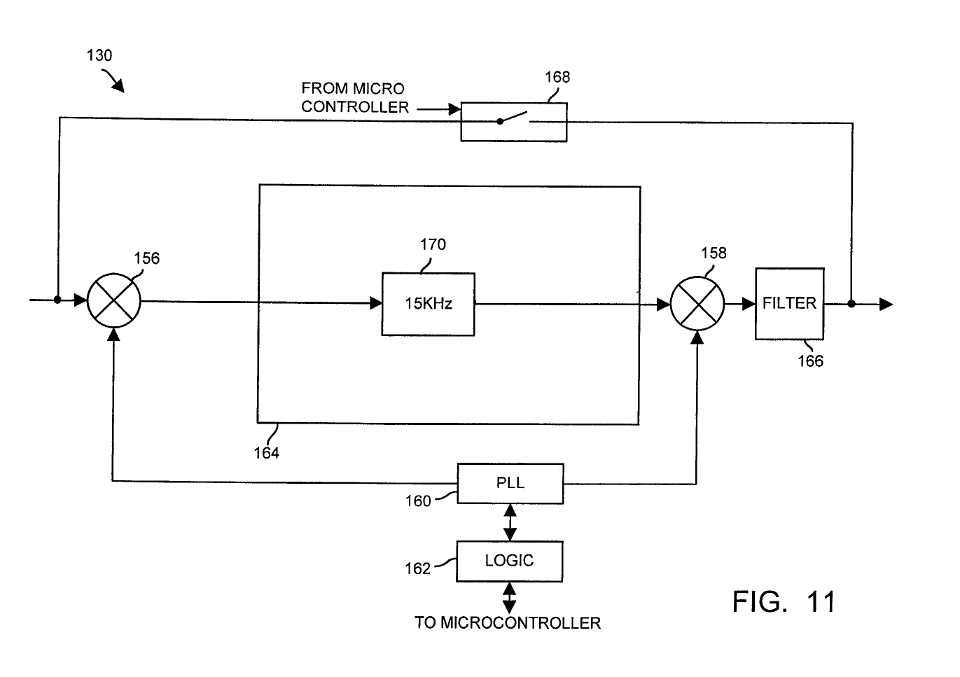

FIG. 11 reveals further detail of one of the notch modules 130, it being understood that any other notch modules used in the ANF module 120 may be substantially identical to the notch module 130. In general, the notch module 130 is an up, down or down, up filter having operational principles similar to the ANF module 80 described in conjunction with FIG. 9. In particular, the notch module 130 includes first and second mixers 156, 158, each of which receives an input signal from a phase locked loop (PLL) 160 that is interfaced through a logic block 162 to the serial bus 156 of the microcontroller 126. Disposed between the mixers 156, 158 is a notch filter block 164, further detail of which is described below. In practice, the mixers 156, 158 may be embodied in model MD54-0005 mixers that are available from M/A-Com and the PLL 160 may be embodied in a model LMX2316TM frequency synthesizer that is commercially available from National Semiconductors

During operation of the ANF module 120, the microcontroller 126 controls the PLL 160 to produce an output signal that causes the first mixer 156 to shift the frequency spectrum of the input signal to an IF, which is the notch frequency of the notch filter block 164. Alternatively, in the case of cascaded notch modules, the notch module may receive its input from another notch module and may not receive the input signal. The output of the PLL 160 is also coupled to the second mixer 158 to shift the frequency spectrum of the signal from the notch filter block 164 back to its original position as it was received, after the notch filter block 164 has removed narrowband interference therefrom. The output of the second mixer 158 is further coupled to a filter 166 to remove any undesired image frequencies that may be produced by the second mixer 158. The output of the filter 166 may be coupled to an additional notch module (e.g., the notch module 132) or, if no additional notch modules are used, may be coupled directly to the next component of the lineup, as shown in FIGS. 1-4.

Additionally, the notch module 130 includes a bypass switch 168 that may be used to bypass the notch module 130 in cases where there is no narrowband interference to be filtered or in the case of a notch module 130 failure. For example, the microcontroller 126 closes the bypass switch 168 when no interference is detected for which the notch module 130 is used to filter. Conversely, the microcontroller 126 opens the bypass switch 168 when interference is detected and the notch module 130 is to be used to filter such interference.

As shown in FIG. 11, the notch filter block 164 includes a filter 170, which may be, for example a filter having a reject band that is approximately 15 KHz wide at −40 dB. The reject band of the filter 170 may be fixed at, for example, a center frequency of 150 MHz or at any other suitable frequency at which the IF of the mixer 156 is located.

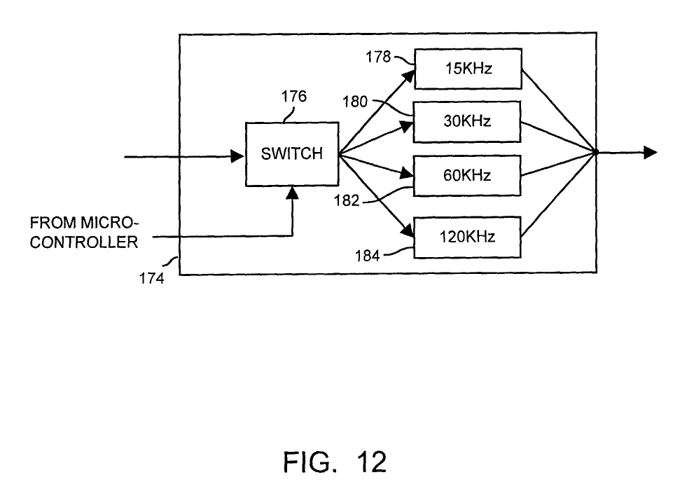

Although the notch filter block 164 of FIG. 11 shows only a single filter 170, as shown in FIG. 12, a second embodiment of a notch filter block 174 may include a switch 176 and multiple filters 178-184. In such an arrangement, each of the filters 178-184 has a notch frequency tuned to the IF produced by the first mixer 156. Additionally, each of the filters 178-184 may have a different reject bandwidth at −40 dB. For example, as shown in FIG. 12, the filters 178-184 have reject bandwidths of 15 KHz to 120 KHz. The use of filters having various reject bandwidths enables the ANF module 100 to select a filter having an optimal reject bandwidth to best filter an interferer.

During operation, of the second embodiment of the notch filter block 174, the microcontroller 126 controls the switch 176 to route the output signal from the first mixer 156 to one of the filters 178-184. The microcontroller 126, via the switch 176, selects the filter 178-184 having a notch switch best suited to filter interference detected by the microcontroller 126. For example, if the microcontroller 126 determines that there is interference on a number of contiguous channels, the microcontroller 126 may use a filter 178-184 having a notch width wide enough to filter all such interference, as opposed to using a single filters to filter interference on each individual channel. Additionally, a single filter having a wide bandwidth may be used when two narrowband channels having interference are separated by a narrowband channel that does not have narrowband interference. Although the use of a single wide bandwidth filter will filter a narrowband channel not having interference thereon, the wideband signal information that is lost is negligible.

Having described the detail of the hardware aspects of the system, attention is now turned to the software aspects of the system. Of course, it will be readily understood by those having ordinary skill in the art that software functions may be readily fashioned into hardware devices such as, for example, application specific integrated circuits (ASICs). Accordingly, while the following description pertains to software, such a description is merely exemplary and should not be considered limiting in any way.

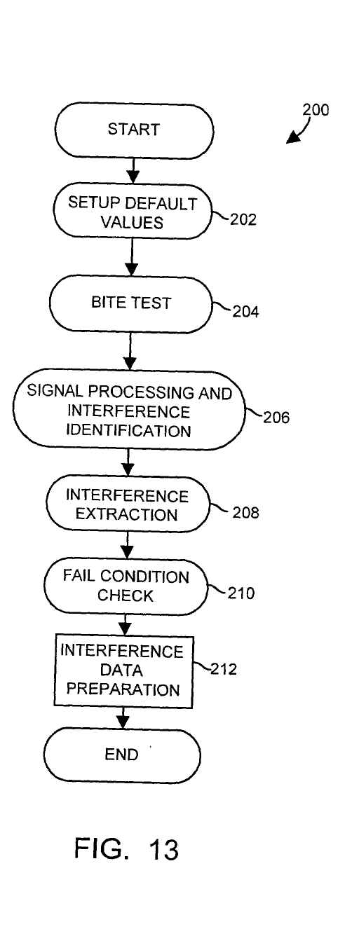

That being said, FIGS. 13-18 include a number of blocks representative of software or hardware functions or routines. If such blocks represent software functions, instructions embodying the functions may be written as routines in a high level language such as, for example, C, or any other suitable high level language, and may be compiled into a machine readable format. Alternatively, instructions representative of the blocks may be written in assembly code or in any other suitable language. Such instructions may be stored within the microcontroller 126 or may be stored within the external memory 138 and may be recalled therefrom for execution by the microcontroller 126.

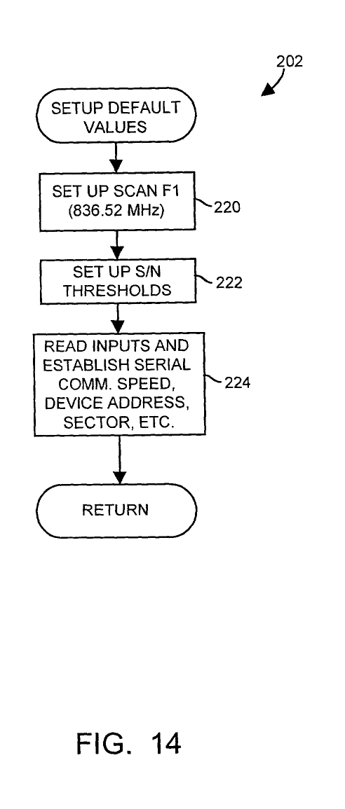

A main routine 200, as shown in FIG. 13, includes a number of blocks or routines that are described at a high level in connection with FIG. 13 and are described in detail with respect to FIGS. 14-18. The main routine 200 begins execution at a block 202 at which the microcontroller 102 sets up default values and prepares to carry out the functionality of the ANF module 120. After the setup default values function is complete, control passes to a block 204, which performs a built-in test equipment (BITE) test of the ANF module 120.

After the BITE test has been completed, control passes from the block 204 to a block 206, which performs signal processing and interference identification. After the interference has been identified at the block 206, control passes to a block 208 where the identified interference is extracted from the wideband signal received by the ANF module 120.

After the interference has been extracted at the block 208, control passes to a block 210 at which a fail condition check is carried out. The fail condition check is used to ensure that the ANF module 120 is operating in a proper manner by checking for gross failures of the ANF module 120.

After the fail condition check completes, control passes from the block 210 to a block 212, which performs interference data preparation that consists of passing information produced by some of the blocks 202-210 from the microcontroller 126 to the OA&M 128. Upon completion of the interference data preparation, the main routine 200 ends its execution. The main routine 200 may be executed by the microcontroller 126 at time intervals such as, for example, every 20 ms.

As shown in FIG. 14, the setup default values routine 202 begins execution at a block 220 at which the microcontroller 126 tunes the programmable local oscillator 154 to scan for interference on a first channel designated as F1. For example, as shown in FIG. 14, F1 may be 836.52 megahertz (MHz). Alternatively, as will be readily appreciated by those having ordinary skill in the art, the first channel to which the ANF module 120 is tuned may be any suitable frequency that lies within the frequency band or guard band of a wideband channel.

After the microcontroller 126 is set up to scan for interference on a first frequency, control passes from the block 220 to a block 222, which sets up default signal to noise thresholds that are used to determine the presence of narrowband interference in input signals. Although subsequent description will provide detail on how adaptive thresholds are generated, the block 222 merely sets up an initial threshold for determining presence of narrowband interference.

After the default thresholds have been set at the block 222 control passes to a block 224 at which the microcontroller 126 reads various inputs, establishes serial communication with the notch modules 130, 132 and any other serial communication devices, as well as establishes communications with the OA&M processor 128. After the block 224 completes execution, the setup default values routine 202 returns control to the main program and the block 204 is executed.

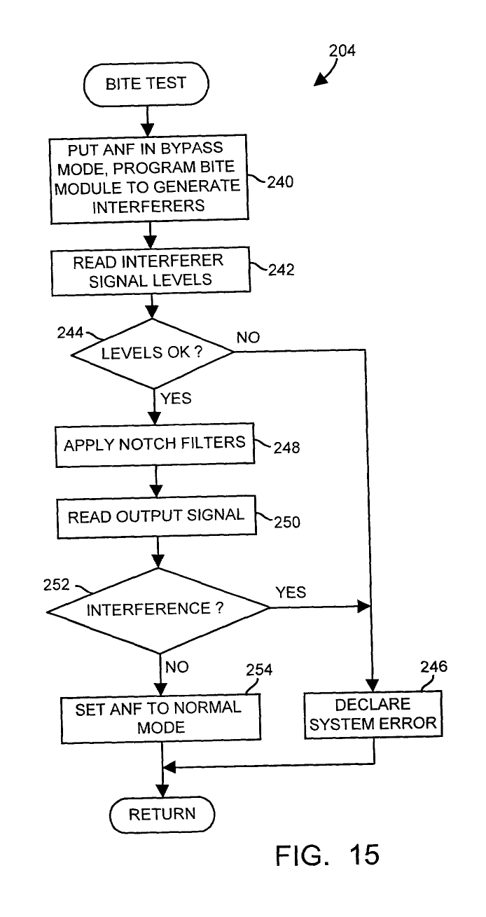

FIG. 15 reveals further detail of the BITE test routine 204, which begins execution after the routine 202 completes. In particular, the BITE test routine 204 begins execution at a block 240, at which the microcontroller 126 puts the notch modules 130, 132 in a bypass mode by closing their bypass switches. After the notch modules 130, 132 have been bypassed, the microcontroller 126 programs the BITE module 134 to generate interferers that will be used to test the effectiveness of the notch modules 130, 132 for diagnostic purposes. After the notch modules 130, 132 have been bypassed and the BITE module 134 is enabled, control passes from the block 240 to a block 242.

At the block 242, the microcontroller 126 reads interferer signal levels at the output of the notch module 132 via the A/D 124. Because the notch modules 130, 132 have been bypassed by the block 240, the signal levels at the output of the notch module 132 should include the interference that is produced by the BITE module 134.

After the interferer signal levels have been read at the block 242, a block 244 determines whether the read interferer levels are appropriate. Because the notch modules 130, 132 have been placed in bypass mode by the block 240, the microcontroller 126 expects to see interferers at the output of the notch module 132. If the levels of the interferer detected at the output of the notch module 132 are not acceptable (i.e., are too high or too low), control passes from the block 244 to a block 246 where a system error is declared. Declaration of a system error may include the microcontroller 126 informing the OA&M processor 128 of the system error. The OA&M processor 128, in turn, may report the system error to a reporting and control facility. Additionally, declaration of a system error may include writing the fact that a system error occurred into the external memory 138 of the microcontroller 126.

Alternatively, if the block 244 determines that the interferer levels are appropriate, control passes from the block 244 to a block 248 at which the microcontroller 126 applies one or more of the notch modules, 130, 132. After the notch modules 130, 132 have been applied (i.e., not bypassed) by the block 248, control passes to a block 250, which reads the signal level at the output of the notch module 132. Because the BITE module 134 produces interference at frequencies to which the notch filters are applied by the block 248, it is expected that the notch modules 130, 132 remove such interference.

After the signal levels are read by the block 250, control passes to a block 252, which determines if interference is present. If interference is present, control passes from the block 252 to the block 246 and a system error is declared because one or more of the notch modules 130, 132 are not functioning properly because the notch modules 130, 132 should be suppressing the interference generated by the BITE module 134. Alternatively, if no interference is detected at the block 252, the ANF module 120 is functioning properly and is, therefore, set to a normal mode of operation at a block 254. After the block 254 or the block 246 have been executed, the BITE test routine 204 returns control to the main program 200, which begins executing the block 206.

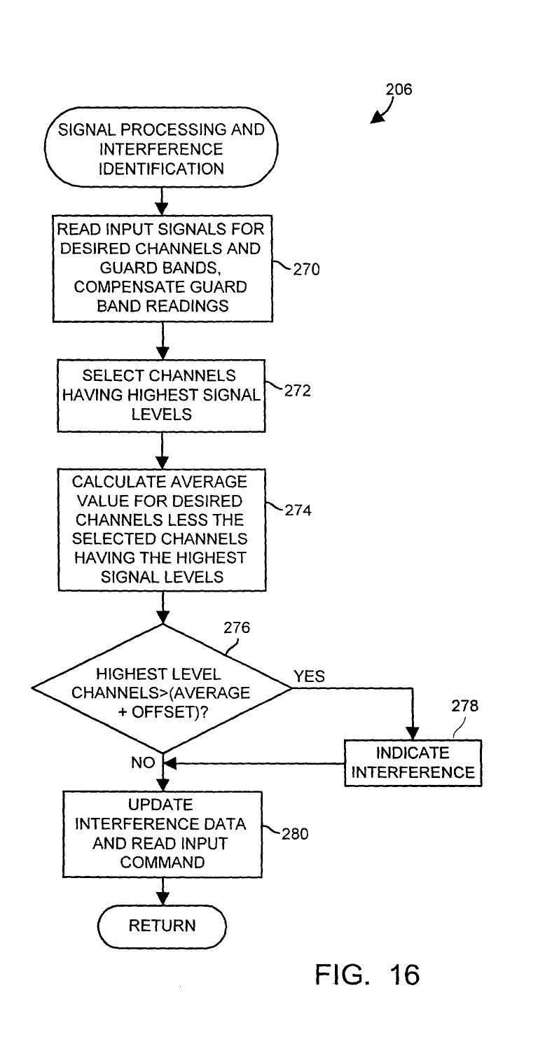

As shown in FIG. 16, the signal processing and interference identification routine 206 begins execution at a block 270. At the block 270, the microprocessor 126 controls the programmable local oscillator 154 so that the microcontroller 126 can read signal strength values for each of the desired channels via the discriminator 152 and the A/D 124. In particular, the microcontroller 126 may control the programmable local oscillator 154 to tune sequentially to a number of known channels. The tuning moves each of the known channels to the IF so that the discriminator 152 can make an RSSI reading of the signal strength of each channel. Optionally, if certain channels have a higher probability of having interference than other channels, the channels having the higher probability may be scanned first. Channels may be determined to have a higher probability of having interference based on historical interference patters or interference data observed by the ANF module 120.

Additionally, at the block 270, the microcontroller 126 controls the programmable local oscillator 154 to frequency shift portions of the guard bands to the IF so that the discriminator 152 can produce RSSI measurements of the guard bands. Because the guard bands are outside of a frequency response of a filter disposed within the wideband receiver 26, the block 270 compensates guard band signal strength reading by reducing the values of such readings by the amount that the guard bands will be attenuated by a receiver filter within the wideband receiver 26. Compensation is carried out because the ANF module 120 is concerned with the deleterious effect of narrowband signals on the wideband receiver 26. Accordingly, signals having frequencies that lie within the passband of the filter of the wideband receiver 26 do not need to be compensated and signals falling within the guard band that will be filtered by the receive filter of the wideband receiver 26 need to be compensated. Essentially, the guard band compensation has a frequency response that is the same as the frequency response of the wideband receiver filter. For example, if a wideband receiver filter would attenuate a particular frequency by 10 dB, the readings of guard bands at that particular frequency would be attenuated by 10 dB.

After the block 270 is completed, control passes to a block 272, which selects a number of channels having the highest signal levels. Commonly, the number of channels that will be selected by the block 272 corresponds directly to the number of notch modules, 130, 132 that are employed by a particular ANF module 120. After the channels having the highest signal levels are selected by the block 272, control passes from the block 272 to a block 274.

At the block 274, the microcontroller 126 determines an adaptive threshold by calculating an average signal strength value for the desired channels read by the block 270. However, the average is calculated without considering the channels having the highest signal levels that were selected by the block 272. Alternatively, it would be possible to calculate the average by including the signal levels selected by the block 272. The block 274 calculates an average that will be compensated by an offset and used to determine whether narrowband interference is present on any of the desired channels read by the block 270.

After the block 274 completes execution control passes to a block 276, which compares the signal strength values of the channels selected by the block 272 to the adaptive threshold, which is the sum of the average calculated by the block 274 threshold and an offset. If the selected channels from the block 272 have signal strengths that exceeds the adaptive threshold, control passes to a block 278.

The block 278 indicates the channels on which interference is present based on the channels that exceeded the adaptive threshold. Such an indication may be made by, for example, writing information from the microcontroller 126 to the external memory 138, which is passed to the OA&M processor 128. After the interferers have been indicated by the block 278, control passes to a block 280. Additionally, if none of the channels selected by the block 272 have signal strengths that exceed the adaptive threshold, control passes from the block 276 to the block 280.

At the block 280, the microcontroller 126 updates an interference data to indicate on which channels interferers were present. In particular, each frame (e.g., 20 ms) the microcontroller 126 detects interferers by comparing power levels (RSSI) on a number of channels to the threshold level. When an Interferer is detected, data for that interferer is collected for the entire time that the interferer is classified as an interferer (i.e., until the RSSI level of the channel falls below the threshold for a sufficient period of time to pass the hang time test that is described below). All of this information is written to a memory (e.g., the memory 138 or 140), to which the OA&M processor 128 has access. As described below, the OA&M processor 128 processes this information to produce the interference report.

Additionally, the block 280 reads input commands that may be received from the OA&M processor 128. Generally, such commands may be used to perform ANF module 120 configuration and measurement. In particular, the commands may be commands that put the ANF module 120 in various modes such as, for example, a normal mode, a test mode in which built in test equipment is employed or activated, or a bypass mode in which the ANF module 120 is completely bypassed. Additionally, commands may be used to change identifying characteristics of the ANF module 120. For example, commands may be used to change an identification number of the ANF module 120, to identify the type of equipment used in the ANF module 120, to identify the geographical location of the ANF module 120 or to set the time and date of a local clock within the ANF module 120. Further, commands may be used to control the operation of the ANF module 120 by, for example, adding, changing or deleting the narrowband channels over which the ANF module 120 is used to scan or to change manually the threshold at which a signal will be classified as an interferer. Further, the attack time and the hang time, each of which is described below, may be changed using commands. Additionally, a command may be provided to disable the ANF module 120.

After the block 280 has completed execution, the signal processing and interference identification routine 260 returns control back to the main routine 200, which continues execution at the block 208.

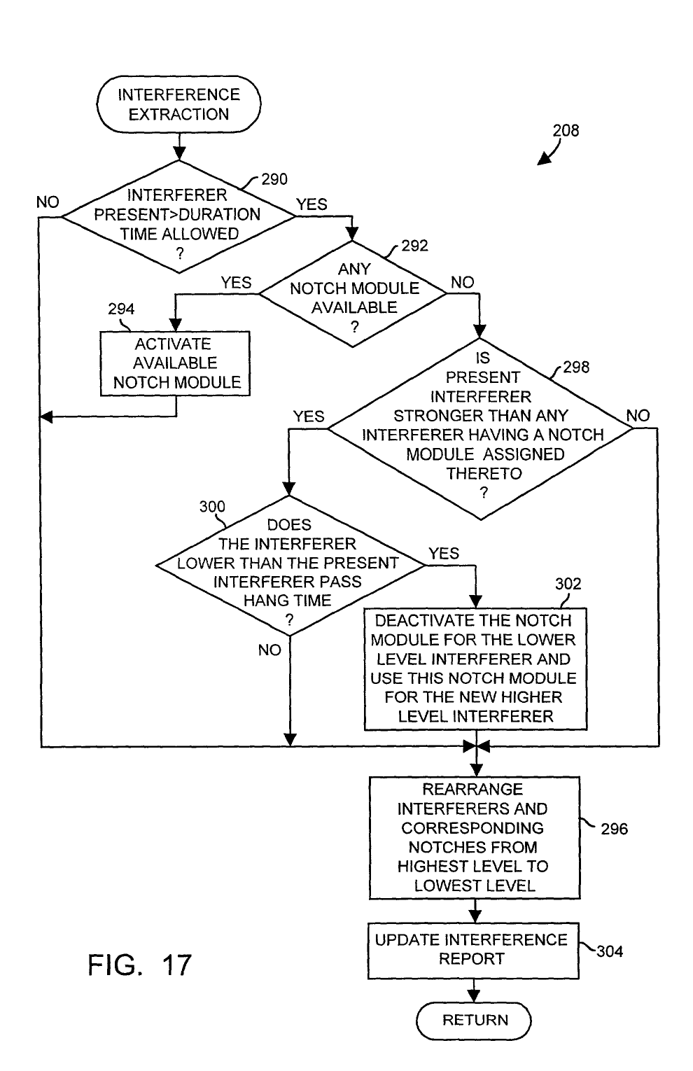

As shown in FIG. 17, the interference extraction routine 208 begins execution at a block 290, which compares the time duration that an interferer has been present with a reference time called “duration time allowed,” which may also be referred to as “attack time.” If the interferer has been present longer than the attack time, control passes to a block 292. Alternatively, if the interferer has not been present longer than the duration time allowed, control passes to a block 296, which is described in further detail below. Essentially, the block 290 acts as a hysteresis function that prevents filters from being assigned to temporary interferers immediately as such interferers appear. Typically, the duration time allowed may be on the order of 20 milliseconds (ms), which is approximately the frame rate of a CDMA communication system. As will be readily appreciated by those having ordinary skill in the art, the frame rate is the rate at which a base station and a mobile unit exchange data. For example, if the frame rate is 20 ms, the mobile unit will receive a data burst from the base station every 20 ms. The block 290 accommodates mobile units that are in the process of initially powering up. As will be appreciated by those having ordinary skill in the art, mobile units initially power up with a transmit power that is near the mobile unit transmit power limit. After the mobile unit that has initially powered up establishes communication with a base station, the base station may instruct the mobile unit to reduce its transmit power. As the mobile unit reduces its transmit power, the mobile unit may cease to be an interference source to a base station having an ANF module. Accordingly, the block 290 prevents the ANF module 120 from assigning a notch module 130, 132 to an interferer that will disappear on its own within a short period of time.

At the block 292, the microcontroller 126 determines whether there are any notch modules 130, 132 that are presently not used to filter an interferer. If there is a notch module available, control passes from the block 292 to a block 294, which activates an available notch module and tunes that notch module to filter the interferer that is present in the wideband signal. After the block 294 has completed execution, control passes to the block 296, which is described below.

If, however, the block 292 determines that there are no notch modules available, control passes from the block 292 to a block 298, which determines whether the present interferer is stronger than any interferer to which a notch module is presently assigned. Essentially, the block 298 prioritizes notch modules so that interferers having the strongest signal levels are filtered first. If the block 298 determines that the present interferer is not stronger than any other interferer to which a notch module is assigned, control passes from the block 298 to the block 296.

Alternatively, if the present interferer is stronger than an interferer to which a notch module is assigned, control passes from the block 298 to a block 300. The block 300 determines whether the interferer that is weaker than the present interferer passes a hang time test. The hang time test is used to prevent the ANF module 120 from deassigning a notch module 130, 132 from an interferer when the interferer is in a temporary fading situation. For example, if a mobile unit is generating interference and a notch module 130, 132 has been assigned to filter that interference, when the mobile unit enters a fading situation in which the interference level is detected at an ANF module 120 becomes low, the ANF module 120 does not deassign the notch module being used to filter the fading interference until the interference has not been present for a time referred to as hang time. Essentially, hang time is a hysteresis function that prevents notch modules from being rapidly deassigned from interferers that are merely temporarily fading and that will return after time has passed. Accordingly, if the interferer that is weaker than the present interferer passes hang time, control passes to a block 302. Alternatively, if the interferer weaker than the present interferer does not pass hang time, the block 300 passes controlled to the block 296.

At the block 302, the microcontroller 126 deactivates the notch module being used to filter the weaker interferer and reassigns that same notch module to the stronger interferer. After the block 302 has completed the reassignment of the notch module, control passes to the block 296.

At the block 296, the microcontroller 126 rearranges interferers from lowest level to highest level and assigns notches to the highest level interferers. As with the block 298, the block 296 performs prioritizing functions to ensure that the strongest interferers are filtered with notch modules. Additionally, the block 296 may analyze the interference pattern detected by the ANF module 120 and may assign filters 178-184 having various notch widths to filter interferers. For example, if the ANF module 120 detects interference on contiguous channels collectively have a bandwidth of 50 KHz, the 50 KHz filter 182 of the notch filter block 164 may be used to filter such interference, rather than using four 15 KHz filters. Such a technique essentially frees up notch filter modules 130, 132 to filter additional interferers.

After the block 296 has completed execution, control passes to a block 304, which updates interference data by sending a list of channels and their interference status to a memory (e.g., the memory 138 or 140) that may be accessed by the OA&M processor 128. After the block 304 has completed execution, the interference extraction routine 208 returns control to the main module 200, which continues execution at the block 210.

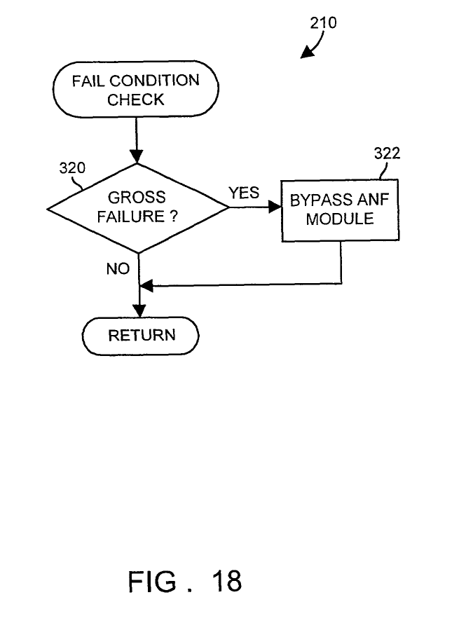

At the block 210, as shown in FIG. 18, the microcontroller 126 determines if a gross failure has occurred in the ANF module 120. Such a determination may be made by, for example, determining if a voltage output from a voltage regulator of the ANF module 120 has an appropriate output voltage. Alternatively, gross failures could be determined by testing to see if each of the notch modules 130, 132 are inoperable. If each of the notch modules is inoperable, it is likely that a gross failure of the ANF module 120 has occurred. Either way, if a gross failure has occurred, control passes from the block 320 to a block 322 at which point the microcontroller 126 enables the bypass switch 136 of FIG. 10 to bypass all of the notch modules 130, 132 of the ANF module 120, thereby effectively connecting the input signals to the output of the ANF module 120. After the execution of the block 322, or if the block 320 determines that a gross failure has not occurred, control passes back to the main routine 200, which continues execution at the block 212. At the block 212, the interference data that was written to the memory 138 or 140, is passed to the OA&M processor 128.

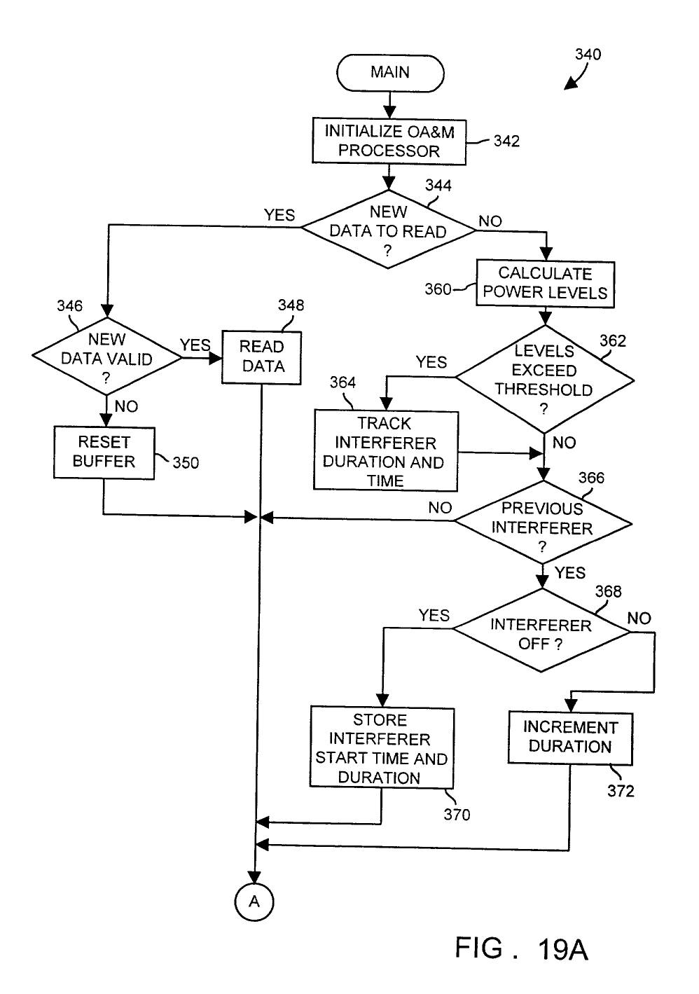

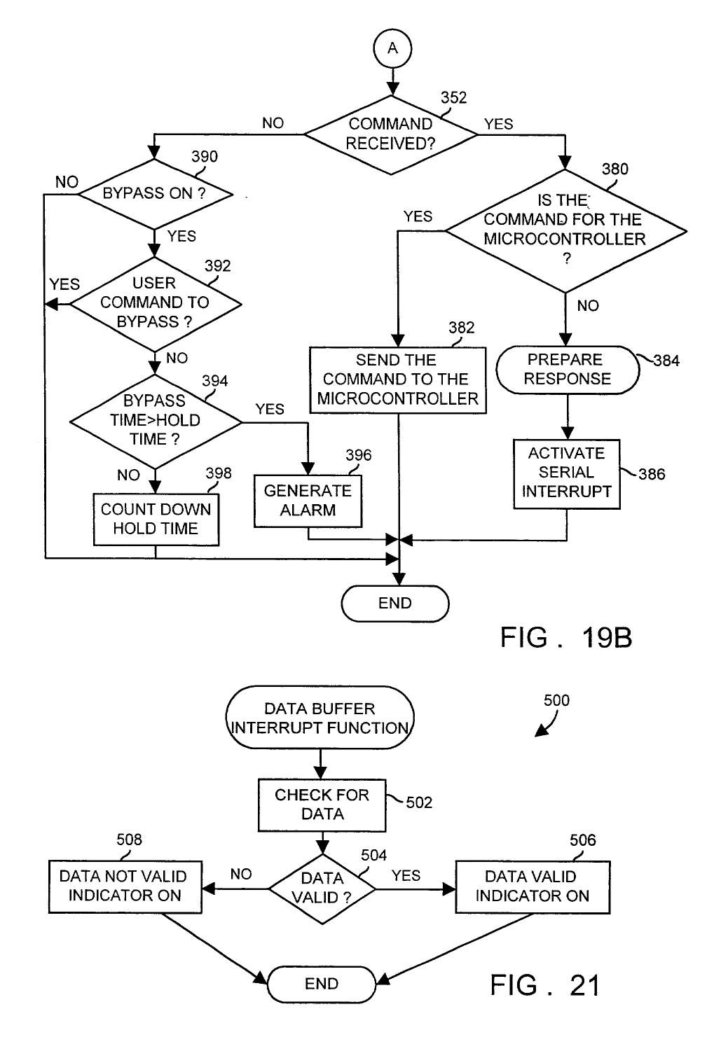

Having described the functionality of the software that may be executed by the microcontroller 126, attention is now turned to the OA&M processor 128 of FIG. 10. If the blocks shown in FIG. 19 represent software functions, instructions embodying the functions may be written as routines in a high level language such as, for example, C, or any other suitable high level language, and may be compiled into a machine readable format. Alternatively, instructions representative of the blocks may be written in assembly code or in any other suitable language. Such instructions may be stored within the OA&M processor 128 or may be stored within the external memory 140 and may be recalled therefrom for execution by the OA&M processor 128.

In particular, as shown in FIGS. 19A and 19B, which are referred to herein collectively as FIG. 19, a main routine 340 executed by the OA&M processor 128 may begin execution at a block 342, at which the OA&M processor 128 is initializes itself by establishing communication, checking alarm status and performing general housekeeping tasks. At the block 342, the OA&M processor 128 is initialized and passes control to a block 344.

At the block 344, the OA&M processor 128 determines whether there is new data to read from an OA&M buffer (not shown). If the block 344 determines that there is new data to read, control passes to a block 346, which determines if the new data is valid. If the new data is valid, control passes from the block 346 to a block 348, which read the data from the OA&M buffer. Alternatively, if the block 346 determines that the new data is not valid, control passes from the block 346 to a block 350, which resets the OA&M buffer. After the execution of either the block 348 or the block 350, control passes to a block 352, which is described in further detail hereinafter.

Returning to the block 344, if the block 344 determines that there is no new data to be read, control passes to a block 360, which calculates power levels of each of the channels scanned by the ANF module 120. The OA&M processor 128 is able to calculate power levels at the block 360 because the data generated as the microcontroller 126 of the ANF module 120 scans the various channels is stored in a buffer that may be read by the OA&M processor 128.

After the power levels have been calculated at the block 360, control passes to a block 362, which determines if the any of the calculated power levels exceed a predetermined threshold. If the calculated power levels do exceed the predetermined threshold, control passes from the block 362 to a block 364, which tracks the duration and time of the interferer before passing control to a block 366. Alternatively, if the block 362 determines that none of the power levels calculated to the block 360 exceed the predetermined threshold, control passes from the block 362 directly to the block 366.

The block 366 determines whether the interferer being evaluated was previously denoted as an interferer. If the block 366 determines that the interferer being evaluated was not previously an interferer, control passes to the block 352. Alternatively, the block 366 passes control to a block 368.

At the block 368, the OA&M processor 128 determines whether the present interferer was a previous interferer that has disappeared, if so, the OA&M processor 128 passes control to a block 370. Alternatively, if the present interferer has not disappeared, control passes from the block 368 to a block 372.

At the block 370, the OA&M processor 128 stores the interferer start time and duration. Such information may be stored within the OA&M processor 128 itself or may be stored within the external memory 140 of the OA&M processor 128. After the block 370 has completed execution, control passes to the block 352. At the block 372, the duration of the interferer is incremented to represent the time that the interferer has been present. After the execution of block 372, control passes to the block 352.

The block 352 determines whether a command has been received at the OA&M processor 128 from the reporting and control facility. If such a command has been received, control passes from the block 352 to a block 380. At the block 380, the OA&M processor 128 determines if the command is for the microcontroller 126 of the ANF module 120, or if the command is for the OA&M processor 128. If the command is for the microcontroller 126, control passes from the block 380 to a block 382, which sends the command to the microcontroller 126. After the execution of the block 382, the main routine 340 ends.

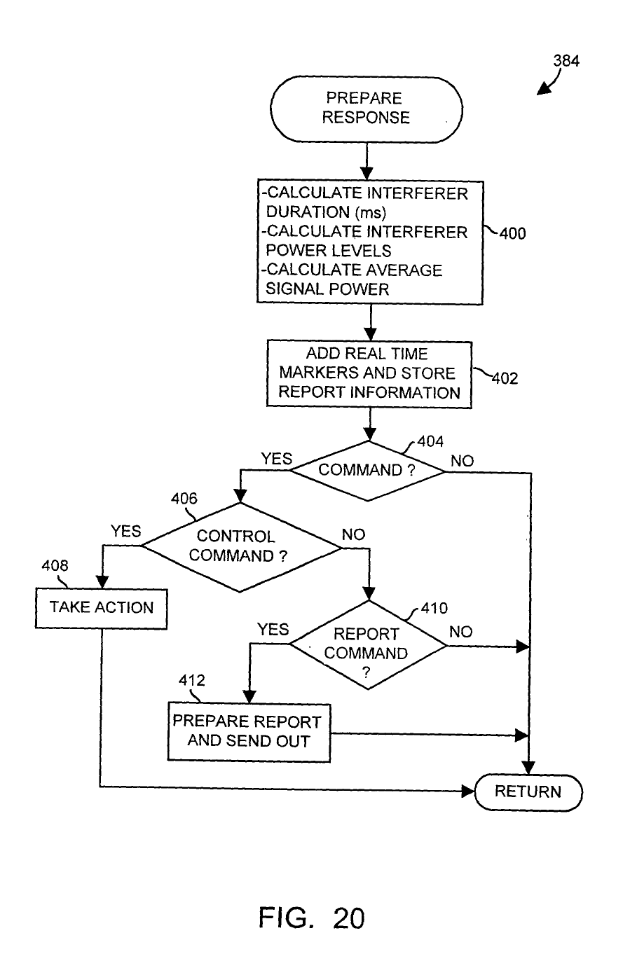

Alternatively, if the command received by the OA&M processor 128 is not a command for the microcontroller 126, control passes from the block 380 to a block 384, which prepares a response to the command. Responses may include simple acknowledgments or may include responses including substantive data that was requested. Further detail on the block 384 is provided in conjunction with FIG. 20. After the block 384 has prepared a response, a block 386 activates the serial interrupt of the OA&M processor 128 and ends execution of the main routine 340.

Alternatively, if the block 352 determines that a command was not received, control passes from the block 352 to a block 390, which determines if the bypass switch 136 of FIG. 10 is closed (i.e., the bypass is on). If the block 390 determines that the bypass is not on, the execution of the main routine 340 ends. Alternatively, if the block 390 determines that the bypass is on, control passes from the block 390 to a block 392.

At the block 392, the OA&M processor 128 determines whether there was a prior user command to bypass the ANF module 120 using the bypass switch 136. If such a user command was made, execution of the main routine 340 ends. Alternatively, if there was no prior user command bypass the ANF module 120, control passes from the block 392 to a block 394, which compares the bypass time to a hold time. If the bypass time exceeds the hold time, which may be, for example, one minute, control passes from the block 394 to a block 396.

At the block 396, an alarm is generated by the OA&M processor 128 and such an alarm is communicated to a reporting and control facility by, for example, pulling a communication line connected to the reporting and control facility to a 24 volt high state. After the execution of the block 396, the main routine 340 ends.

Alternatively, if the block 394 determines that the bypass time has not exceeded the hold time, control passes from the block 394 to a block 398, which counts down the hold time, thereby bringing the bypass time closer to the hold time. Eventually, after the block 398 sufficiently decrements the hold time, the block 394 will determine that the bypass time does exceed the hold time and pass control to the block 396. After the block 398 has completed execution, the main routine 340 ends.

As shown in FIG. 20, the prepare response routine 384 begins execution at a block 400. At the block 400, the OA&M processor 128 reads information that the microcontroller 126 has written into a buffer (e.g., the memory 138 or 140) and calculates the duration of the interferers that are present, calculates interferer power levels and calculates the average signal power. This information may be stored locally within the ANF module 120 or may be reported back to a network administrator in real time. Such reporting may be performed wirelessly, over dedicated lines or via an Internet connection. The interferer power levels and the average signal power may be used to evaluate the spectral integrity of a geographic area to detect the presence of any fixed interferers that may affect base station performance. Additionally, such information may be used to correlate base station performance with the interference experienced by the base station. After the block 400 completes execution, control passes through a block 402.

At the block 402, the OA&M processor 128 adds real time markers to the information calculated in the block 400 and stores the report information including the real time markers and the information calculated in the block 400. Such information may be stored within the OA&M processor 128 itself or may be stored within the external memory 140 of the OA&M processor 128.

After the block 402 has completed execution, control passes to a block 404, which determines whether a command has been received by the ANF module 120. Such commands would be received from a reporting and control facility. If the block 404 determines that no command has been received by the OA&M processor 128, control passes from the block 404 back to the main routine 340, which continues execution at the block 386.

Alternatively, if the block 404 determines that a command has been received by the OA&M processor 128, control passes from the block 404 to a block 406, which determines if the received command is a control command that would be used to control the operation of the ANF module 120 from a remote location, such as the reporting and control facility. If the block 406 determines that the command received is a control command, the block 406 transfers control to a block 408 which takes the action prescribed by the command. Commands may include commands that, for example, commands that enable or disable remote control of the ANF module 120, or may include any other suitable commands. After the execution of the block 408, control passes from the prepare response routine 384 back to the main routine 340, which then ends execution.

Alternatively, if the block 406 determines that the command received by the OA&M processor 128 is not a control command, control passes from the block 406 to a block 410, which determines if the received command is a report command. If the command was not a report command, the block 410 passes control back to the main routine 340. Alternatively, if the block 410 determines that the received command is a report command, control passes from the block 410 to a block 412, which prepares and sends out the interference report. The interference report may include information that shows the parameters of the most recent 200 interferers that were detected by the ANF module 120 and the information on which the microcontroller 126 wrote to a memory 138, 140 that the OA&M processor 128 accesses to prepare the interference report. The interference report may include the frequency number (channel) on which interference was detected, the RF level of the interferer, the time the interferer appeared, the duration of the interferer and the wideband signal power that was present when the interferer was present.

In addition to the interference report, the OA&M processor 128 may prepare a number of different reports in addition to the interference report. Such additional reports may include: mode reports (report the operational mode of the ANF module 120), status reports (reports alarm and system faults of the ANF module 120), software and firmware version reports, header reports (reports base station name, wideband carrier center frequency, antenna number and base station sector), date reports, time reports, activity reports (reports frequency number, RF level, interferer start time, interferer duration, and wideband channel power) and summary reports.

The interference report may be used for network system diagnostic purposes including determining when the network administrator should use a narrowband receiver to determine a telephone number that the mobile unit is attempting to contact and, optionally handling the call. For example, the reporting and control facility may use a narrowband receiver to determine that the user of the mobile unit was dialing 911, or any other emergency number, and may, therefore, decide that a narrowband receiver should be used to handle the emergency call by routing the output of a narrowband receiver to a telephone network.

Additionally, the interference report may be used to determine when a network administrator should control a narrowband receiver to obtain particular information relating to an interferer and retasking the interferer by communicating with its base station. For example, the reporting and control facility may use a narrowband receiver to determine the identity of an interferer, such as a mobile unit, by intercepting the electronic serial number (ESN) of the mobile unit, which is sent when the mobile unit transmits information on the narrowband channel. Knowing the identity of the interferer, the reporting and control facility may contact infrastructure that is communicating with the mobile unit and may request the infrastructure to change the transmit frequency of the mobile unit (i.e., the frequency of the narrowband channel on which the mobile unit is transmitting) or may request the infrastructure to drop communications with the interfering mobile unit all together.

Further, the interference reports may be used by a network administrator to correlate system performance with the information provided in the interference report. Such correlations could be used to determine the effectiveness of the ANF module 120 on increasing system capacity.

After the block 412 has completed execution, control passes back to the main routine 340, which continues execution at the block 386.

Referring now to FIG. 21, a data buffer interrupt function 500 is executed by the OA&M processor 128 and is used to check for, and indicate the presence of, valid data. The function 500 begins execution at a block 502, which checks for data.

After the execution of the block 502, control passes to a block 504, which checks to see if the data is valid. If the block 504 determines that the data is valid, control passes from the block 504 to a block 506, which sets a valid data indicator before the function 500 ends. Alternatively, if the block 504 determines that the data is not valid, control passes from the block 504 to a block 508, which sets a not valid data indicator before the function 500 ends.

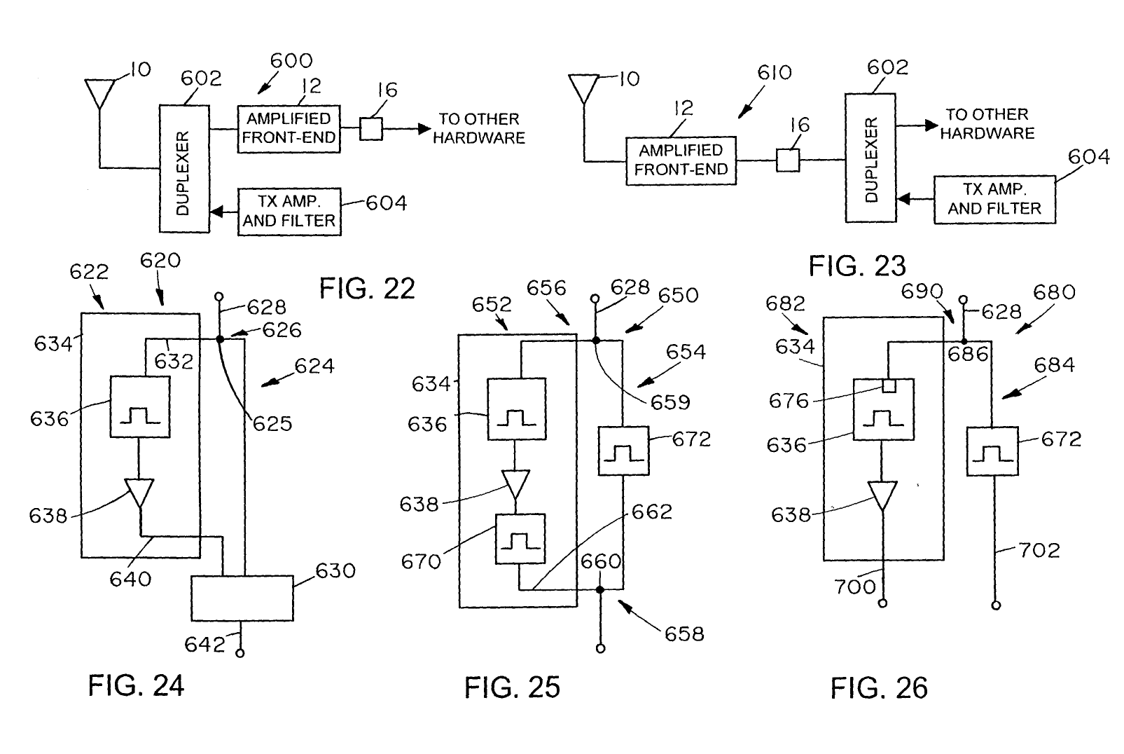

Referring now to FIG. 22, any of the base stations lineups shown in FIGS. 1-3 may be modified to include a duplexing arrangement 600. The duplexing arrangement 600 would be installed between the antenna 10 and, in the case of FIGS. 1 and 2, the OEM front-end 14. Alternatively, in the case of FIG. 3, the duplexing arrangement 600 would be installed between the antenna 10 and the ANF module 22. The duplexing arrangement 600 includes a duplexer 602 connected to the antenna 10 and to both the front-end 12 and a transmission amplifier and filter 604. The duplexer 602 may be embodied in a phased combination of transmit and receive filters. Such filters may be embodied in conventional filter technology or in HTS filter technology.

In such an arrangement, the duplexer 602 passes transmission signals from the transmission amplifier and filter 604 to the antenna 10 and passes received signals from the antenna 10 to the front-end 12.

An alternate duplexing arrangement 610, shown in FIG. 23 may also be substituted into any of the base station lineups shown in FIGS. 1-3. In such cases, the duplexing arrangement 610 would be installed between the antenna 10 and, in the case of FIGS. 1 and 2, the OEM front-end 14. Alternatively, in the case of FIG. 3, the duplexing arrangement could be installed between the antenna 10 and the ANF module 22. The duplexing arrangement 610 of FIG. 23 requires the front-end 12 to pass signals both to and from the antenna 10 on a single input and output transmission line. Front-end systems adapted to handle duplexed signals in this manner are described below in conjunction with FIGS. 24 and 25.

With reference now to FIG. 24, a dual-duplexed front-end system indicated generally at 620 is shown as having a receive path 622 and a transmit path 624 that are joined together at a node 625 of a coupler 626 such that a single cable 628 carries both the reception and transmission signals to the antenna (see FIG. 23). Additionally, the receive path 622 and the transmit path 624 are coupled together by a stand-alone duplexer 630. Suitable duplexers 630 for use in the front-end system 620 include one or more bandpass filters, and are available from Lorch Microwave (Salisbury, Md.).

The coupler 626 of the front end system 620 also includes a phase-adjusting portion 632 disposed in a cryostat 634 that houses components of the front-end system 620 that are operated in a cryogenic environment. The cryostat 634 may, for example, be constructed in accordance with the teachings of commonly assigned U.S. patent application Ser. No. 08/831,175, the disclosure of which is hereby incorporated by reference.

A low-loss bandpass receive filter 636 is also disposed in the cryostat 634 such that any losses introduced by the receive filter 636 are minimal or low. The receive filter 636 may, but need not, include an HTS material in the interest of maintaining extremely low-losses despite high amounts of rejection. In general, such HTS bandpass filters are available from, for example, Illinois Superconductor Corporation (Mt. Prospect, Ill.). More particularly, the receive filter 636 may constitute an all-temperature, dual-mode filter constructed in accordance with the teachings of commonly assigned U.S. patent application Ser. No. 09/158,631, the disclosure of which is hereby incorporated by reference. While incorporating HTS technology to minimize losses, the dual-mode filter remains operational at an acceptable filtering level despite a failure in the cooling system. Alternatively, the receive filter 636 includes bypass technology as set forth in the aforementioned U.S. Pat. No. 6,104,934 or in commonly assigned U.S. patent application Ser. No. 09/552,295, the disclosure of which is hereby incorporated by reference. It should be noted, however, that any necessary phase-adjustment for blocking transmit signals may need to be addressed in a bypass path as well.

The receive filter 636 may alternatively constitute a filter system having two or more cascaded filters in accordance with the teachings of commonly assigned U.S. patent application Ser. No. 09/130,274, the disclosure of which is hereby incorporated by reference. Such cascaded filter arrangements may provide extremely high levels of rejection without the difficulties associated with tuning a single highly selective filter. In such an embodiment, not all of the filters in the filter system need be disposed within the cryostat 634.

The receive filter 636 may utilize either thick or thin film technology or a hybrid of both. In the event that HTS materials are utilized, a thick film resonant structure may be constructed in accordance with the teachings of U.S. Pat. No. 5,789,347, the disclosure of which is hereby incorporated by reference. Furthermore, such HTS filters may need to be further protected from the transmission signals, that is, beyond the protection provided by the phase-adjusting portion 632. To this end, the receive filter 636 may be modified so as to function acceptably well even if a fraction of the power transmitted by the transmission signal is experienced by the receive filter 636. For example, a fraction of the transmission signal may impact the receive filter 636 even if the phase-adjusting portion 632 properly establishes destructive interference for signals at the transmission signal frequency. Accordingly, some portion or all of the receive filter 636 may be modified to be capable of handling the dissipation of energy associated with the fraction of the transmission signal.

Also disposed in the cryostat 634 is a low-noise amplifier (LNA) 638, that sets the noise figure for the receive path 622 of the front-end system 620. Examples of a suitable LNA are set forth in the above-referenced U.S. patents and patent applications. The output of the LNA 638 is coupled to the duplexer 630 via a cable 640. The duplexer 630 has a cable 642 that may be coupled to the remainder of the base station lineup.

The phase-adjusting portion 632 is preferably disposed in the cryostat 634, as shown, such that any losses associated therewith are minimized as a result of operation at cryogenic temperatures. In one embodiment utilizing additional cabling having an appropriate length for destructive interference, the losses associated with the added length are minimized.

With reference now to FIG. 25, an alternative dual-duplexed front-end system 650 includes a customized dual-duplex configuration that does not rely upon a stand-alone, off-the-shelf duplexer. More particularly, the front-end system 650 includes a receive path 652 and a transmit path 654 that are coupled at both ends with couplers indicated generally at 656 and 658. The couplers 656 and 658 include nodes 659 and 660, respectively. The couplers 656 and 658 may be similar to those described hereinabove and, for example, may utilize a cable of a certain length that establishes destructive interference in the receive path 652 for signals at the transmission signal frequency. To minimize losses associated with such cabling, all or a portion of such phase-adjustment may occur in the cryostat 634 such that, in general, phase-adjusting portions 661, 662 of the couplers 656, 658, respectively, are disposed in the cryostat 634.

The front-end system 650 also includes an additional bandpass filter 670 for the purpose of protecting the LNA from transmission signals. The filter 670 may, but need not, be disposed in the cryostat 634 as shown in FIG. 25. Similarly, the filter 670 may be an HTS filter as set forth hereinabove in connection with the low-loss receive filter 636. Also shown in FIG. 25 is a transmit filter 672.

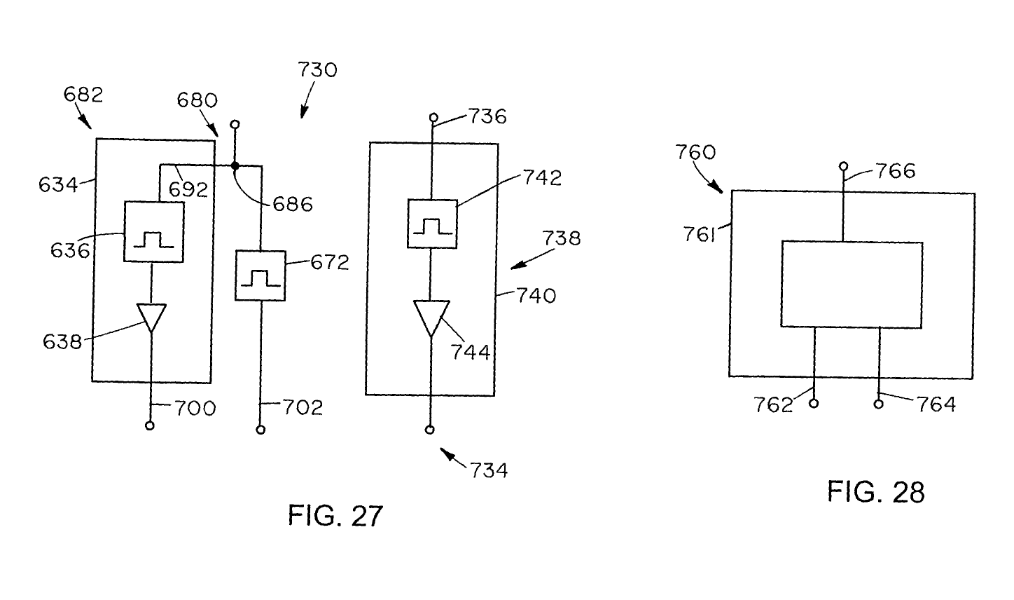

While the configurations shown in FIGS. 24 and 25 each have two connections and, therefore, may be substituted for the front-end 12 of FIG. 23, FIGS. 26-27, as described below, may be substituted for the front-end, and the duplexer 602 of FIG. 23.

With reference now to FIG. 26, a front-end system indicated generally at 680 includes a receive path 682 and a transmit path 684 for carrying reception and transmission signals, respectively. The receive and transmit paths 682 and 684 are coupled together at a node 686 such that the cable 628 carries both the reception and transmission signals to the antenna (see FIG. 23). The coupling establishes a duplexed configuration and is provided via a coupler indicated generally at 690. The coupler 690 includes a phase-adjusting portion 692 disposed in the cryostat 634 that houses components of the front-end system 680 that operate in a cryogenic environment.

Some portion or all of the receive filter 636 may be modified to be capable of handling the dissipation of energy associated with the fraction of the transmission signal. For example, the receive filter 636 may include a first stage 696 that has been modified to include only conventional materials (e.g., copper, silver, or gold) or to include higher proportions of such conventional materials (see, for example, the above-referenced patent application regarding a dual-mode filter).

In the embodiment of FIG. 26, only single-duplex functionality is provided, inasmuch as another cable or cabling 698 is included for carrying the transmission signals from the base station to the transmit path 684 of the front-end system 680. The receive path 682 and the transmit path 684 each include cables 700, 702, respectively.

With reference now to FIG. 27, a diversity-receive front-end system indicated generally at 730 includes a main section 732 and a diversity-receive section 734. Generally speaking, the main section 732 may have a duplexed configuration in accordance with any of the aforementioned front-end system of FIG. 24-26, despite being shown as including the components of the front-end system 680 of FIG. 26.

The diversity-receive section 734 includes a cable or cabling 736 that couples a diversity front-end indicated generally at 738 to a diversity antenna (not shown). The diversity front-end 738 may include a separate cryostat 740 or utilize the same cryostat 634 utilized by the main section 732. A bandpass filter 742 and LNA 744 are disposed in the cryostat 740 for processing of the reception signals collected by the diversity antenna in the same manner as in the main section 732. As a result, the filter 742 and LNA 744 may include the same or similar components and materials as that described hereinabove in connection with the filter 636 and LNA 638.

In general, the manner in which the main and diversity sections are housed is not critical to the practice of certain aspects of the invention, but may result in certain efficiencies and advantages when combined in a common housing.

FIG. 28 shows an HTS duplexer 760 that could be used to replace the amplified front-end 12 and the duplexer 602 of the embodiment of FIG. 23. Generally speaking, the HTS duplexer 760 is disposed in a cryostat 761 that may be the same or distinct from any other cryostat described hereinabove, and includes a pair of HTS bandpass filters (not shown) that permit reception signals on a first input/output line 762 to be duplexed with transmission signals on a second input/output line 764. Such bandpass filters may include bypass networks or all temperature components as set forth hereinabove. In any case, the duplexer 760 either inputs or outputs the duplexed signals on a line 766 in accordance with the knowledge of one skilled in the art.

As used herein, a “coupler” should not be understood to refer to the specific RF device commonly referred to as an “RF coupler”, but rather more generally to refer a device capable of establishing a suitable transmission line for carrying signals in the desired frequency range between the points or devices being coupled.

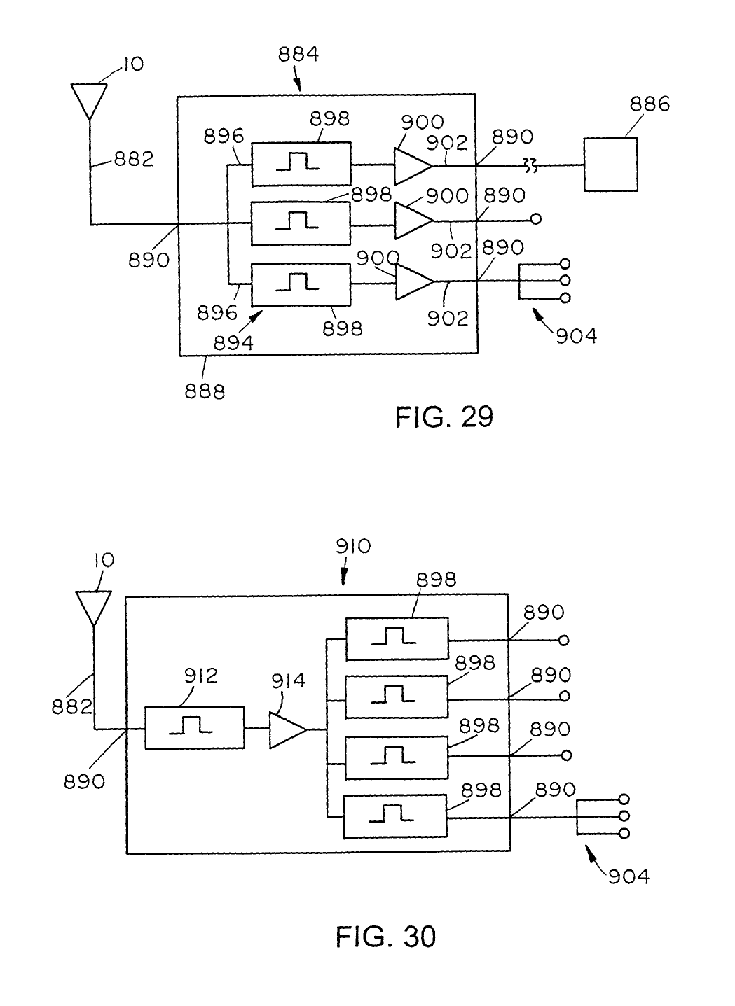

Generally, FIGS. 29 and 30 illustrate front-ends that may be implemented with multiple outputs. In particular, with reference to FIG. 29, an antenna 880, the particular structure of which is not pertinent to the practice of the present invention, provides an antenna signal on a transmission line 882 to a front-end indicated generally at 884. The antenna signal collected by the antenna 880 is actually a composite signal having a number of constituent signals representative of respective information. For instance, the constituent signals may be representative of voice information, data, and the like. The constituent signals are processed by the front-end 884 in preparation for further processing by one or more receivers 886 that translate one or more of the constituent signals from the RF domain to an intermediate or IF stage, as well as to stages suitable for digital signal processing of the received information.

The transmission line 882 may constitute any coaxial or other cabling suitable for RF signals in the frequency bands utilized for wireless communication. The material and structure of the cabling is selected in the interest of minimizing losses through matching impedances and minimizing the length of the cable, as well as in accordance with other considerations known to those skilled in the art.

As will be described in further detail herein below, the front-end 884 includes high-performance components that operate in a cooled environment maintained by a cooling system (not shown) that may include or, alternatively, support a cooled vessel 888. The cooled vessel 888 is preferably a cryostat that houses and, therefore, cools the cryogenic components of the front-end 884. More generally, the cooling system is preferably a cryo-cooler or cryo-refrigerator The cryostat may, for example, be constructed in accordance with the teachings of commonly assigned U.S. patent application Ser. No. 08/831,175. Generally speaking, however, cryo-refrigeration that maximizes heat lift while drawing a minimum amount of power is preferred for use with the present invention. At present, Stirling-cycle coolers shown to draw 200 Watts or less are preferred for use in connection with the present invention. As will be described hereinafter, such highly efficient cooling machines are utilized to address the significant head load brought about by multi-coupling in the front-end 884, which accordingly leads to multiple output connections, each presenting the system with additional heat load.

The cooled vessel 888 has multiple input/output ports or connections 890 that couple the cryogenic components to ambient components disposed outside of the cryostat. Ambient components include cabling 892 leading from the front-end 884 to the remainder of the base station or receiver 886. The specific details of the manner in which the front-end is coupled to the remainder of the base station are well known in the art and, except as noted herein, not relevant to the practice of the present invention.

The input/output ports 890 serve as a thermal interface between the cryogenic and ambient environments and, as is known in the art, may effect significant heat loss through the utilization of thermal conductive cabling. Accordingly, one aspect of the present invention is directed to minimizing the heat load provided by the input/output connections 890, particularly in light of the increased number of outputs required by the multiple receive paths brought about by the multi-coupling of the present invention.

In accordance with one embodiment of the present invention, and continued reference to FIG. 29, the front-end 884 includes a plurality of receive paths that include RF elements that process either the composite antenna signal or the constituent signals extracted therefrom. The processing occurs in a cooled environment (i.e., in the cooled vessel 888) such that very low insertion losses are realized thereby. More particularly, the front-end 884 includes a manifold indicated generally at 894 having a plurality of coupling lines 896 coupled to the input/output connection 890 leading to the antenna 880. The manifold 894 feeds a plurality of receive paths with a portion (i.e., a particular constituent signal) of the composite signal collected by the antenna 880. As a result, the number of receive paths is commensurate with the number of constituent signals contained in the composite signal.

Each coupling line 896 is designed to couple a respective constituent signal in an efficient manner to a respective RF bandpass filter 898, which is tuned to a center frequency and passband commensurate with the respective constituent signal. Generally speaking, the manifold 894 and coupling lines 896 are structured to provide a low-loss multi-coupling arrangement. More particularly, each coupling line 896 preferably constitutes a transmission line and/or coupling mechanism to a respective filter 898 that isolates the receive path in question from the other constituent signals distributed by the manifold 894. In this manner, minimal power losses occur as a result of the distribution of the composite signal amongst the respective receive paths. In one embodiment, each coupling line 896 consists of a certain length of cable that changes the input impedance of the respective filter 898 for frequencies other than the passband of the filter. Such an approach to multi-coupling is well-known and will not be further described herein. Other embodiments provide the necessary impedance modification via the input coupling for the initial stage of the filter 898, as is also well known to those skilled in the art.

Once each constituent signal has been extracted from the composite signal, each constituent signal is amplified by a respective low-noise amplifier (LNA) 900 that sets the noise figure for the respective receive path. The amplified signal provided by the LNA 900 is, in turn, provided to one of the output ports 890 via cabling 902.

The processing of each constituent signal as set forth above provides a way for the base station to optimize receiver sensitivity for each type of technology, transmission format, channel type, etc. Each processed signal path provides an input to the subsequent receivers that has been optimized with respect to bandwidth and gain. This minimizes the likelihood of interference which reduces the sensitivity or useable dynamic range of these receivers, and instead maximizes the coverage and/or capacity performance of these receivers. To this end, the front-end 14 provides a filtered signal via the output ports 890 to the receiver(s) 886 using the minimum bandwidth required. The front-end 884 may also provide a filtered signal that may allow the convenient integration of standard next generation receivers, as service providers migrate their systems to offer new data and multi-media features. Additionally, one or more of the output ports 890 of the front-end may be connected to a channel filter (not shown) and a ANF module (not shown).

In accordance with one embodiment of the present invention, the cabling 902 includes extra or added length to decrease the heat load provided by each input/output connection 890 for each receive path. Adding length to the cabling 902 increases the thermal resistance in that cabling, thereby minimizes heating of components in the cryostat. Alternatively, or in addition, the cabling 902 has a structure or material designed to lower or minimize thermal conduction. Certain of such structures or materials are shown in U.S. Pat. Nos. 5,856,768 and 6,207,901, the disclosures of which are hereby incorporated by reference. In addition, in some types of filters, magnetic coupling schemes can be used to couple signals between filters and cabling which connects outside the cryostat. Such magnetic coupling will not require the conductors in the cabling to physically contact the components in the cryostat, thereby providing a measure of thermal isolation. A lower thermal conductivity material or structure may lead to higher losses, but such losses would occur downstream of the LNA 900 and, therefore, be relatively insignificant. For a three sectored site with receiver diversity, the addition of each separate filtered path in the front-end 894 adds 6 additional output lines. If the heat load for these additional cables is not managed for minimum heat loss, the capacity of the cooler may become inadequate to maintain an optimum operating temperature and performance of the system is degraded. Even if the capacity of the cooler remains adequate for maintaining an optimum operating temperature, the increase in heat load will degrade the cooldown time associated with the this equipment.

The constituent signals may constitute either analog or digital transmission signals, and/or multiple channels of a particular technology, such as CDMA. As shown in FIG. 29, the manifold 894 may feed any number of receive paths. Furthermore, the receive paths may have the same or different bandwidths or center frequencies. In one embodiment, a receive path may includes multiple channels distributed over the entire bandwidth of its corresponding filter 898. In such cases, downstream of the filter 898 and amplifier 900, further multi-coupling is provided via an additional manifold 904, which may be inside or outside the cryostat 888.

FIG. 30 shows an alternative front-end indicated generally at 910. Elements common to one or more figures are identified with like reference numerals. The front-end 910 differs from the embodiment shown in FIG. 29 in that wide-band filtering or selection occurs prior to any multi-coupling or distribution of the constituent signals. In this manner, a wide-band RF filter 912 is coupled to the antenna 880 and an LNA 914 sets the noise figure for the entire wide band, irrespective of any particular requirements for a certain channel, etc. While certain gain adjustments may need to occur downstream of the front-end 910 for this reason, the front-end 910 need only include a single LNA in the cooled vessel 888. This trade-off may lead to lower heat load as well as a lower cost front-end.

The bandpass filters 898 (as well as the filter 912) are disposed in the cryostat 888 such that any losses introduced thereby are minimal or low. Each filter 898 or 912 may, but need not, include an HTS material in the interest of maintaining extremely low losses despite high amounts of rejection. Each filter 898 or 912 may constitute an all-temperature, dual-mode filter constructed in accordance with the teachings of commonly assigned U.S. patent application Ser. No. 09/158,631. While incorporating HTS technology to minimize low losses, the dual-mode filter remains operational at an acceptable filtering level despite a failure in the cooling system. Alternatively, each filter 898 includes bypass technology as set forth in the aforementioned U.S. Pat. No. 6,104,934 or in commonly assigned U.S. patent application Ser. No. 09/552,295. It should be noted, however, that any necessary phase-adjustment for blocking transmit signals may need to be addressed in a bypass path as well.

Each filter 898 or 912 may alternatively constitute a filter system having two or more cascaded filters in accordance with the teachings of commonly assigned U.S. patent application Ser. No. 09/130,274. Such cascaded filter arrangements may provide extremely high levels of rejection without the difficulties associated with tuning a single low-loss, highly selective filter.

Each filter 898 or 912 may utilize either thick or thin film technology or a hybrid of both. In the event that HTS materials are utilized, a thick film resonant structure may be constructed in accordance with the teachings of U.S. Pat. No. 5,789,347.

With regard to the LNAs 900, examples of a suitable LNA are set forth in the above-referenced U.S. patents and patent applications.

Numerous modifications and alternative embodiments of the invention will be apparent to those skilled in the art in view of the foregoing description. For example, while the foregoing description specifically addressed the concept of eliminating interference from signals on 30 KHz narrowband channels interfering with a 1.25 MHz wideband signal, it will be readily appreciated that such concepts could be applied to wideband channels having, for example, 5, 10 or 15 MHz bandwidths or to contiguous channels that have an aggregate bandwidth of, for example, 5, 10 or 15 MHz. To accommodate such wider bandwidths, banks of downconverters may be operated in parallel to cover 1.25 MHz block of the channel. Accordingly, this description is to be construed as illustrative only and not as limiting to the scope of the invention. The details of the structure may be varied substantially without departing from the spirit of the invention, and the exclusive use of all modifications, which are within the scope of the appended claims, is reserved.

What is claimed is:

1. A communication station having an antenna for receiving a communication signal, the communication station comprising:
a low-loss filter having an input and an output, wherein the input of the low-loss filter is coupled to the antenna;
a low-noise amplifier having an input and an output, wherein the input of the low-noise amplifier is coupled to the output of the low-loss filter;
an adaptive notch filter (ANF) module having an input and an output, wherein the input of the ANF module is coupled to the output of the low-noise amplifier; and
a receiver having an input coupled to the output of the ANF module and responsive to the communication signal.

2. The communication station of claim 1, wherein the communication signal comprises a wideband communication signal.

3. The communication station of claim 1, wherein the communication signal comprises a signal modulated with a code-based modulation scheme.

4. The communication station of claim 3, wherein the code-based modulation scheme comprises a code-division multiple access (CDMA) scheme.

5. The communication station of claim 3, wherein the code-based modulation scheme comprises a wideband code-division multiple access (W-CDMA) scheme.

6. The communication station of claim 1, wherein the low-loss filter comprises a high-temperature superconducting component.

7. The communication station of claim 6, wherein the low-noise amplifier is a cryogenic amplifier.

8. The communication station of claim 6, wherein the low-noise amplifier comprises a high-temperature superconductor (HTS) component.

9. The communication station of claim 1, wherein the low-loss filter is coupled directly to the low-noise amplifier.

10. The communication station of claim 1, wherein the low-noise amplifier is coupled directly to the ANF module.

11. The communication station of claim 6, further comprising a channel filter coupled between the low-noise amplifier and the ANF module.

12. The communication station of claim 1, wherein the channel filter has a passband that is narrower than a passband of the low-loss filter.

13. The communication station of claim 11, further comprising a splitter coupled between the low-noise amplifier and the ANF module.

14. The communication station of claim 1, wherein the antenna, the low-loss filter and the low-noise amplifier are mounted on an antenna tower.

15. The communication station of claim 1, wherein the ANF module has an output third-order intercept (TOI) performance that exceeds the equivalent output TOI performance of the low-loss filter and the low-noise amplifier.

16. The communication station of claim 1, wherein the low-noise amplifier has gain that is optimized to balance noise figure performance and intermodulation distortion performance at the output of the ANF module.

17. The communication station of claim 1, further comprising an original equipment manufacturer (OEM) front-end coupled between the low-noise amplifier and the ANF module.

18. The communication station of claim 17, further comprising a splitter between the OEM front-end and the ANF module.

19. The communication station of claim 18, wherein the low-noise amplifier has first gain and the OEM front-end has a second gain and wherein the first and second gains are optimized to balance noise figure performance and intermodulation distortion performance at the output of the ANF module.

20. The communication station of claim 1, wherein the low-loss filter and the low-noise amplifier comprise a portion of a receive front-end system having multiple outputs.

21. The communication station of claim 1, wherein the low-loss filter and the low-noise amplifier comprise a portion of a duplexer.

22. A communication station having an antenna for receiving a communication signal, the communication station comprising:
a low-loss filter having an input and an output, wherein the input of the low-loss filter is coupled to the antenna;
a low-noise amplifier having an input and an output, wherein the input of the low-noise amplifier is coupled to the output of the low-loss filter;
a channel filter having an input and an output, wherein the input of the channel filter is coupled to the output of the low-noise amplifier;
an adaptive notch filter (ANF) module having an input and an output, wherein the input of the ANF module is coupled to the output of the channel filter; and
a receiver having an input coupled to the output of the ANF module and responsive to the communication signal.

23. The communication station of claim 22, wherein the communication signal comprises a wideband communication signal.

24. The communication station of claim 22, wherein the communication signal comprises a signal modulated with a code-based modulation scheme.

25. The communication station of claim 24, wherein the code-based modulation scheme comprises a code-division multiple access (CDMA) scheme.

26. The communication station of claim 24, wherein the code-based modulation scheme comprises a wideband code-division multiple access (W-CDMA) scheme.

27. The communication station of claim 22, wherein the low-loss filter comprises a high-temperature superconducting component.

28. The communication station of claim 27, wherein the low-noise amplifier is a cryogenic amplifier.

29. The communication station of claim 27, wherein the low-noise amplifier comprises a high-temperature superconductor (HTS) component.

30. The communication station of claim 22, wherein the low-loss filter is coupled directly to the low-noise amplifier.

31. The communication station of claim 22, wherein the low-noise amplifier is coupled directly to the channel filter.

32. The communication station of claim 22, wherein the channel filter has a passband that is narrower than a passband of the low-loss filter.

33. The communication station of claim 22, further comprising a splitter coupled between the low-noise amplifier and the channel filter.

34. The communication station of claim 22, wherein the antenna, the low-loss filter and the low-noise amplifier are mounted on an antenna tower.

35. The communication station of claim 22, wherein the ANF module has an output third-order intercept (TOI) performance that exceeds the equivalent output TOI performance of the low-loss filter and the low-noise amplifier.

36. The communication station of claim 22, wherein the low-noise amplifier has gain that is optimized to balance noise figure performance and intermodulation distortion performance at the output of the ANF module.

37. The communication station of claim 22, further comprising an original equipment manufacturer (OEM) front-end coupled between the low-noise amplifier and the ANF module.

38. The communication station of claim 37, wherein the low-noise amplifier has first gain and the OEM front-end has a second gain and wherein the first and second gains are optimized to balance noise figure performance and intermodulation distortion performance at the output of the ANF module balanced gain claims

39. A communication station having an antenna for receiving a communication signal, the communication station comprising:
a low-loss filter having an input and an output, wherein the input of the low-loss filter is coupled to the antenna;
a low-noise amplifier having a first gain, an input and an output, wherein the input of the low-noise amplifier is coupled to the output of the low-loss filter;
an original equipment manufacturer (OEM) front-end having a second gain, an input and an output, wherein the input of the OEM front-end is coupled to the output of the low-noise amplifier;
an adaptive notch filter (ANF) module having an input and an output, wherein the input of the ANF module is coupled to the output of the OEM front-end and wherein the first and second gains are optimized to balance noise figure performance and intermodulation distortion performance at the output of the ANF module; and
a receiver having an input coupled to the output of the ANF module and responsive to the communication signal.

40. The communication station of claim 39, wherein the communication signal comprises a wideband communication signal.

41. The communication station of claim 39, wherein the communication signal comprises a signal modulated with a code-based modulation scheme.

42. The communication station of claim 41, wherein the code-based modulation scheme comprises a code-division multiple access (CDMA) scheme.

43. The communication station of claim 41, wherein the code-based modulation scheme comprises a wideband code-division multiple access (W-CDMA) scheme.

44. The communication station of claim 39, wherein the low-loss filter comprises a high-temperature superconducting component.

45. The communication station of claim 44, wherein the low-noise amplifier is a cryogenic amplifier.

46. The communication station of claim 44, wherein the low-noise amplifier comprises a high-temperature superconductor (HTS) component.

47. The communication station of claim 39, wherein the low-loss filter is coupled directly to the low-noise amplifier.

48. The communication station of claim 39, wherein the low-noise amplifier is coupled directly to the OEM front-end.

49. The communication station of claim 39, wherein the OEM front-end is coupled directly to the ANF module.

50. The communication station of claim 39, further comprising a channel filter coupled between the OEM front-end and the ANF module.

51. The communication station of claim 39, wherein the channel filter has a passband that is narrower than a passband of the low-loss filter.

52. The communication station of claim 50, further comprising a splitter coupled between the OEM front-end and the channel filter.

53. The communication station of claim 39, wherein the antenna, the low-loss filter and the low-noise amplifier are mounted on an antenna tower.

54. The communication station of claim 39, wherein the ANF module has an output third-order intercept (TOI) performance that exceeds the equivalent output TOI performance of the low-loss filter, the OEM front-end and the low-noise amplifier.

55. The communication station of claim 39, wherein the low-noise amplifier has a first gain and the OEM front-end has a second gain, wherein the first and second gains are optimized to balance noise figure performance and intermodulation distortion performance at the output of the ANF module.

56. The communication station of claim 39, wherein the low-loss filter and the low-noise amplifier comprise a portion of a receive front-end system having multiple outputs.

57. The communication station of claim 39, wherein the low-loss filter and the low-noise amplifier comprise a portion of a duplexer. TOI/IMD claims

58. A communication station having an antenna for receiving a communication signal, the communication station comprising:
a low-loss filter having an input and an output, wherein the input of the low-loss filter is coupled to the antenna;
a low-noise amplifier having an input and an output, wherein the input of the low-noise amplifier is coupled to the output of the low-loss filter;
an adaptive notch filter (ANF) module having an input and an output, wherein the ANF module has an output third-order intercept (TOI) performance that exceeds the equivalent output TOI performance of the low-loss filter and the low-noise amplifier; and
a receiver having an input coupled to the output of the ANF module and responsive to the communication signal.

59. The communication station of claim 58, wherein the communication signal comprises a wideband communication signal.

60. The communication station of claim 58, wherein the communication signal comprises a signal modulated with a code-based modulation scheme.

61. The communication station of claim 60, wherein the code-based modulation scheme comprises a code-division multiple access (CDMA) scheme.

62. The communication station of claim 60, wherein the code-based modulation scheme comprises a wideband code-division multiple access (W-CDMA) scheme.

63. The communication station of claim 58, wherein the low-loss filter comprises a high-temperature superconducting component.

64. The communication station of claim 63, wherein the low-noise amplifier is a cryogenic amplifier.

65. The communication station of claim 63, wherein the low-noise amplifier comprises a high-temperature superconductor (HTS) component.

66. The communication station of claim 58, wherein the low-loss filter is coupled directly to the low-noise amplifier.

67. The communication station of claim 58, wherein the low-noise amplifier is coupled directly to the ANF module.

68. The communication station of claim 58, further comprising a channel filter coupled between the low-noise amplifier and the ANF module.

69. The communication station of claim 68, wherein the channel filter has a passband that is narrower than a passband of the low-loss filter.

70. The communication station of claim 68, further comprising a splitter coupled between the low-noise amplifier and the ANF module.

71. The communication station of claim 58, wherein the antenna, the low-loss filter and the low-noise amplifier are mounted on an antenna tower.

72. The communication station of claim 58, wherein the low-noise amplifier has gain that is optimized to balance noise figure performance and intermodulation distortion performance at the output of the ANF module.

73. The communication station of claim 58, further comprising an original equipment manufacturer (OEM) front-end coupled between the low-noise amplifier and the ANF module.

74. The communication station of claim 73, wherein the low-noise amplifier has first gain and the OEM front-end has a second gain and wherein the first and second gains are optimized to balance noise figure performance and intermodulation distortion performance at the output of the ANF module.

75. The communication station of claim 58, wherein the low-loss filter and the low-noise amplifier comprise a portion of a receive front-end system having multiple outputs.

76. The communication station of claim 58, wherein the low-loss filter and the low-noise amplifier comprise a portion of a duplexer.

77. A communication station having an antenna for receiving a communication signal, the communication station comprising:
an adaptive notch filter (ANF) module having an input and an output, wherein the input of the ANF module is coupled to the antenna;
a low-loss filter having an input and an output, wherein the input of the low-loss filter is coupled to the output of the ANF module;
a low-noise amplifier having an input and an output, wherein the input of the low-noise amplifier is coupled to the output of the low-loss filter; and
a receiver having an input coupled to the output of low-noise amplifier.

78. The communication station of claim 77, wherein the communication signal comprises a signal modulated with a code-based modulation scheme.

79. The communication station of claim 78, wherein the code-based modulation scheme comprises a code-division multiple access (CDMA) scheme.

80. The communication station of claim 78, wherein the code-based modulation scheme comprises a wideband code-division multiple access (W-CDMA) scheme.

81. The communication station of claim 77, wherein the low-loss filter comprises a high-temperature superconducting component.

82. The communication station of claim 81, wherein the low-noise amplifier is a cryogenic amplifier.

83. The communication station of claim 81, wherein the low-noise amplifier comprises a high-temperature superconductor (HTS) component.

84. The communication station of claim 77, wherein the low-loss filter is coupled directly to the low-noise amplifier.

85. The communication station of claim 77, wherein the low-noise amplifier is coupled directly to the receiver.

86. The communication station of claim 77, further comprising a splitter coupled between the low-noise amplifier and the receiver.

87. The communication station of claim 77, wherein the ANF module has an output third-order intercept (TOI) performance that exceeds the equivalent output TOI performance of the low-loss filter and the low-noise amplifier.

88. The communication station of claim 77, further comprising an original equipment manufacturer (OEM) front-end coupled between the low-noise amplifier and the receiver.

89. The communication station of claim 88, wherein the low-noise amplifier has first gain and the OEM front-end has a second gain and wherein the first and second gains are optimized to balance noise figure performance and intermodulation distortion performance at the output of the OEM front-end.

90. The communication station of claim 89, further comprising a splitter coupled to the OEM front-end.

91. A communication station having an antenna for receiving a communication signal, the communication station comprising:
a low-loss filter having an input and an output, wherein the input of the low-loss filter is coupled to the antenna;
a low-noise amplifier having an input and an output, wherein the input of the low-noise amplifier is coupled to the output of the low-loss filter;
a splitter having an input and an output, wherein the input of the splitter is coupled to the output of the low-noise amplifier;
an attenuator having an input and an output, wherein the input of the attenuator is coupled to the output of the splitter output;
a channel filter having an input and an output, wherein the input of the channel filter is coupled to the output of the attenuator;
an adaptive notch filter (ANF) module having an input and an output, wherein the input of the ANF module is coupled to the output of the channel filter; and
a receiver having an input coupled to the output of the ANF module and responsive to the communication signal.

92. The communication station of claim 91, wherein the communication signal comprises a signal modulated with a code-based modulation scheme.

93. The communication station of claim 92, wherein the code-based modulation scheme comprises a code-division multiple access (CDMA) scheme.

94. The communication station of claim 92, wherein the code-based modulation scheme comprises a wideband code-division multiple access (W-CDMA) scheme.

95. The communication station of claim 91, wherein the low-loss filter comprises a high-temperature superconducting component.

96. The communication station of claim 95, wherein the low-noise amplifier is a cryogenic amplifier.

97. The communication station of claim 95, wherein the low-noise amplifier comprises a high-temperature superconductor (HTS) component.

98. The communication station of claim 91, wherein the low-loss filter is coupled directly to the low-noise amplifier.

99. The communication station of claim 91, wherein the antenna, the low-loss filter and the low-noise amplifier are mounted on an antenna tower.

100. The communication station of claim 91, wherein the ANF module has an output third-order intercept (TOI) performance that exceeds the equivalent output TOI performance of the low-loss filter and the low-noise amplifier.

101. The communication station of claim 91, wherein the low-noise amplifier has gain that is optimized to balance noise figure performance and intermodulation distortion performance at the output of the ANF module.

102. The communication station of claim 91, further comprising an original equipment manufacturer (OEM) front-end coupled between the low-noise amplifier and the ANF module.

103. The communication station of claim 102, wherein the low-noise amplifier has first gain and the OEM front-end has a second gain and wherein the first and second gains are optimized to balance noise figure performance and intermodulation distortion performance at the output of the ANF module.

104. A method of processing a communication signal received by an antenna of a communication station, the method comprising:
filtering the communication signal with a low-loss filter to produce a first signal;
amplifying the filtered signal with a low-noise amplifier to produce a second signal;
scanning the second signal for narrowband interference and selectively removing narrowband interference therefrom to produce a third signal; and
demodulating the third signal.

105. The method of claim 104, wherein the communication signal comprises a signal modulated with a code-based modulation scheme.

106. The method of claim 105, wherein the code-based modulation scheme comprises a code-division multiple access (CDMA) scheme.

107. The method of claim 105, wherein the code-based modulation scheme comprises a wideband code-division multiple access (W-CDMA ) scheme.

108. The method of claim 104, wherein the filtering the communication signal comprises filtering the communication signal with a high-temperature superconducting component.

109. The method of claim 108, wherein the low-noise amplifier is a cryogenic amplifier.

110. The method of claim 108, wherein the low-noise amplifier comprises a high-temperature superconductor (HTS) component.

111. The method of claim 104, further comprising filtering the second signal with a channel filter before the second signal is scanned for narrowband interference.

112. The method of claim 111, further comprising splitting the second signal before second signal is filtered with the channel filter.
